(19) United States
(12) Patent Application Publication
(10) Pub. No.: US 2008/0215547 A1
(43) Pub. Date: Sep. 4, 2008

(54) INTRODUCTION SUPPORTING APPARATUS AND RECORDING MEDIUM STORING COMPUTER PROGRAM

(75) Inventors: Tatsuro MATSUMOTO, Kawasaki (JP); Yutaka IWAYAMA, Kawasaki (JP); Eiichi TAKAHASHI, Kawasaki (JP); Masahiro HARA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/021,587

(22) Filed: Jan. 29, 2008

(30) Foreign Application Priority Data
Jan. 30, 2007 (JP) 2007-019916

(51) Int. Cl. G06F 17/30; G06F 7/00

(52) U.S. Cl. 707/3; 707/10; 707/E17.001; 707/E17.014

(57) ABSTRACT

According to an aspect of the invention, an apparatus for supporting an introduction among a plurality of users includes: a receiving unit; a member database; a community database; an extracting unit; a determining unit; and a transmitting unit.

### CROSS-REFERENCE TO RELATED APPLICATIONS

This application is related to and claims priority under 35 U.S.C §119(a) on Japanese Patent Application No. 2007-19916 filed on Jan. 30, 2007 in the Japan Patent Office, and incorporated by reference herein.

### BACKGROUND OF THE INVENTION

1. Field of the Invention

The present invention relates to an introduction supporting apparatus that supports introduction among a plurality of users, and a recording medium in which a computer program for causing a computer to function as the introduction supporting apparatus is recorded.

2. Description of the Related Art

In recent years, services providing communication places by a human network based on user-to-user relationship of trust have become popular. These services are called “social network services” (hereinafter, “SNSs”). Various companies provide diverse SNSs. The SNSs are characterized of their capabilities to designate an opening range of user information, differently from ordinary websites and blogs. User information is the information such as a user profile, a user diary, and photographs of each user. Namely, each user can designate the opening range in SNSs so as to, for example, open the user information up to friends of the user or open the user information up to friends of friends of the user. Such designation of the opening range enables a communication to be held among predetermined users.

There are also known SNSs that enable users to spontaneously create communities according to hobbies such as music or movies, or to categories such as hometowns or schools. If a user creates a specific community in which the user has an interest and other users having similar interests can participate in the community in sequence, the communication can be made more active. Japanese Patent Application Laid-Open No. 2002-236762 discloses a general technique relating to a human network.

If a user wants to participate in a community in an SNS, the user first searches communities so as to find an community which is optimum for the user from among many existing communities. To do a community search, the user inputs a community attribute, a search keyword or the like. A server managing SNSs searches for communities and provides a plurality of community candidates using the input information. The user selects a community to which the user seeks to participate in from among the provided community candidates.

### SUMMARY OF THE INVENTION

According to an aspect of the invention, an apparatus for supporting an introduction among a plurality of users includes: a receiving unit receiving both information on a community and an introduction range corresponding to first identification information on a first user from an information processing apparatus of the first user, the first user seeks introduction the community is one in which the first user is interested in joining, the introduction range is a number of max times intermediating between the first user and a target user to whom the first user seeks introduction; a member database storing identification information on the plurality of users, the identification information is including both the first identification information and the second identification information on a second user who has an established relationship with the first user; a community database storing identification information on users belonging to the community;

an extracting unit extracting target identification information on the target user from the member database using both the first identification information and the introduction range; a determining unit determining whether the extracted target identification information has been stored in the community database related to the community corresponding to the received information on the community; and a transmitting unit transmitting the extracted target identification information and the received information on the community to the information processing apparatus when the determining unit determines that the extracted target identification information has been stored in the community database.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a pattern diagram showing an outline of an introduction supporting system according to a first embodiment of the present invention;

FIG. 2 is a block diagram showing a hardware configuration of a personal computer included in the introduction supporting system shown in FIG. 1;

FIG. 3 is a block diagram showing a hardware configuration of a server computer included in the introduction supporting system shown in FIG. 1;

FIG. 4 is an explanatory diagram showing a record layout of a member DB;

FIG. 5 is an explanatory diagram showing a record layout of a community DB;

FIG. 6 is an explanatory diagram showing a record layout of a page DB;

FIG. 7 is an explanatory diagram showing a displayed image of a top page;

FIG. 8 is an explanatory diagram showing an image of a community registration screen;

FIG. 9 is an explanatory diagram showing an image at the time of deciding an introduction range;

FIG. 10 is an explanatory diagram showing a record layout of a registration file;

FIG. 11 is an explanatory diagram showing an image of a notification form;

FIG. 12 is an explanatory diagram showing an image of an intermediacy request form;

FIG. 13 is an explanatory diagram showing a displayed image of an intermediacy request message;

FIG. 14 is an explanatory diagram showing a displayed image of an introduction request form;

FIG. 15 is an explanatory diagram showing a displayed image of an introduction request message;

FIG. 16 is an operation flow showing procedures of an introduction range registration process;

FIG. 17 is an operation flow showing procedures of the introduction range registration process;

FIG. 18 is an operation flow showing procedures of a notification process;

FIG. 19 is an operation flow showing procedures of an intermediacy process;

FIG. 20 is an operation flow showing procedures of the intermediacy process;

FIG. 21 is an operation flow showing procedures of an introduction request process;

FIG. 22 is an operation flow showing procedures of the introduction request process;

FIG. 23 is an operation flow showing procedures of the introduction request process;

FIG. 24 is an explanatory diagram showing an image of a notification form;

FIG. 25 is an operation flow showing procedures of a notification process according to a second embodiment of the present invention;

FIG. 26 is an explanatory diagram showing an image of a communication registration screen according to a third embodiment of the present invention;

FIG. 27 is an explanatory diagram showing a record layout of a registration file according to the third embodiment;

FIG. 28 is an operation flow showing procedures of a notification process according to the third embodiment;

FIG. 29 is an operation flow showing procedures of the notification process according to the third embodiment; and

FIG. 30 is a block diagram showing a configuration of a server computer included in an introduction supporting system according to a fourth embodiment of the present invention.

### DETAILED DESCRIPTION OF THE EMBODIMENTS

### First Embodiment

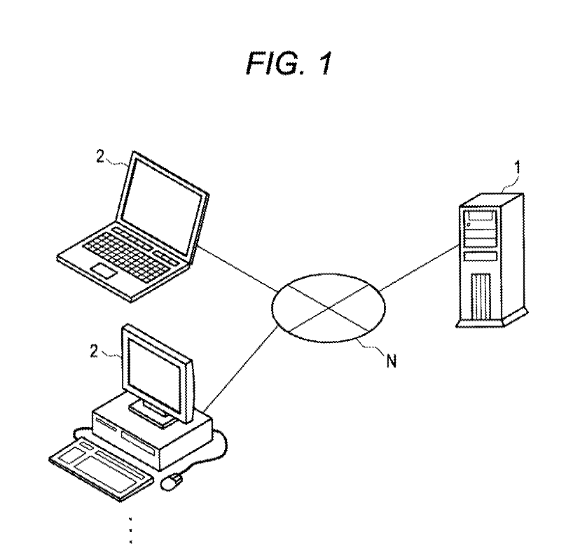

Embodiments of the present invention will be described hereinafter with reference to the accompanying drawings. FIG. 1 is a pattern diagram showing an outline of an introduction supporting system according to a first embodiment of the present invention. The introduction supporting system shown in FIG. 1 includes a plurality of information processing apparatuses 2 used by a plurality of users, respectively, a communication network N such as the Internet, and an introduction supporting apparatus 1. The introduction supporting apparatus 1 executes a series of processes relating to introduction support according to a request from each of the information processing apparatuses 2 in an SNS. As the introduction supporting apparatus 1, a server computer, for example, is used. As the respective information processing apparatuses 2, personal computers are used, for example. The introduction supporting system will be described, assuming that the introduction supporting apparatus 1 is a server computer 1 and the information processing apparatuses 2 are personal computers.

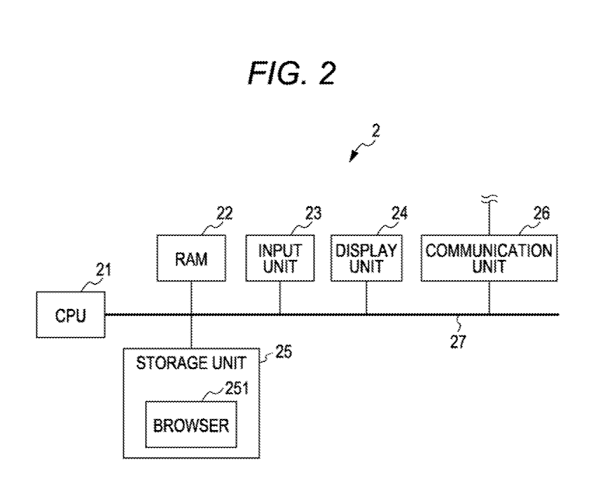

FIG. 2 is a block diagram showing a hardware configuration of each of the personal computers 2. The personal computer 2 is configured to include a central processing unit (CPU) 21 serving as a control unit, a random access memory (RAM) 22, an input unit 23, a display unit 24, a communication unit 26, and a storage unit 25. The CPU 21 is connected to the other hardware constituent elements of the personal computer 2 via a bus 27, respectively. The CPU 21 controls the other hardware constituent elements of the personal computer 2 and executes various software functions according to a control program stored in the storage unit 25.

The display unit 24 is, for example, a liquid crystal display. The input unit 23 is, for example, a keyboard and a mouse. The communication unit 26 is, for example, a modem or a local area network (LAN) card. The communication unit 26 transmits or receives information to or from the server computer 1 using a communication protocol such as HTTP (Hyper Text Transfer Protocol). The storage unit 25 is, for example, a hard disk. The storage unit 25 stores a browser 251 such as Internet Explorer (registered trademark of Microsoft Corporation) in the hard disk.

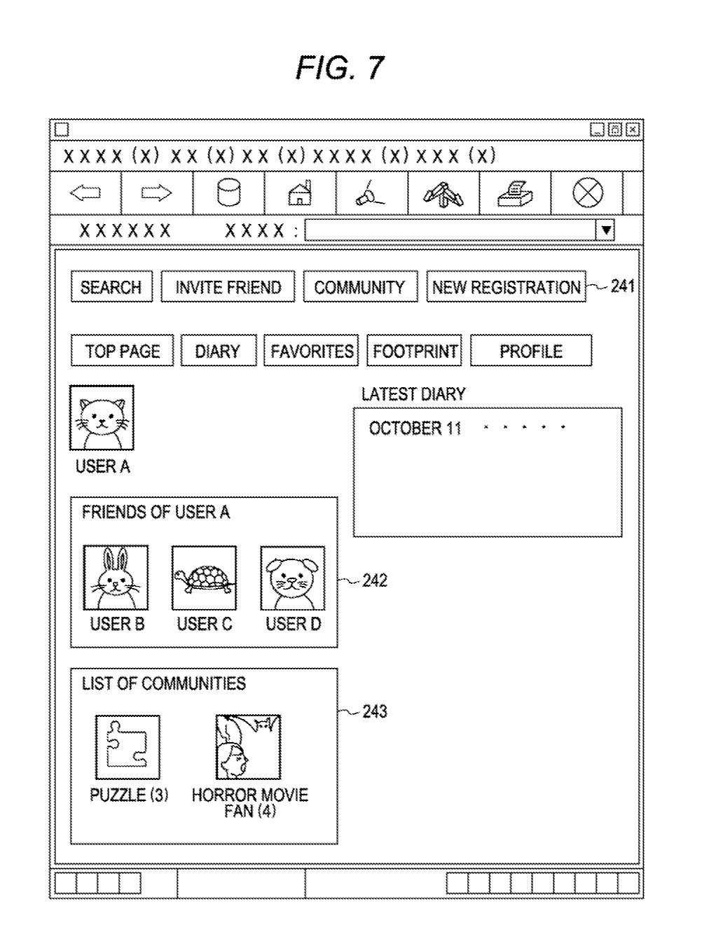

If a user is to access the server computer 1, then the user starts the browser 251 via the input unit 23 and inputs a URL (Uniform Resource Locator) of the server computer 1 to the user's personal computer 2 via the input unit 23. As a result, a top page of the SNS is displayed on the display unit 24. The user inputs a user ID and a password of the user computer 1 via the input unit 23 and transmits the user ID and the password of the user to the server computer 1. Using the user ID and the password of the user, the server computer 1 performs an authentication of the user. If the server computer 1 authenticates the user, then the server computer 1 transmits a page created by the user (to be described later with reference to FIG. 7) to the personal computer 2 of the user and the browser 251 of the personal computer 2 of the user displays the page.

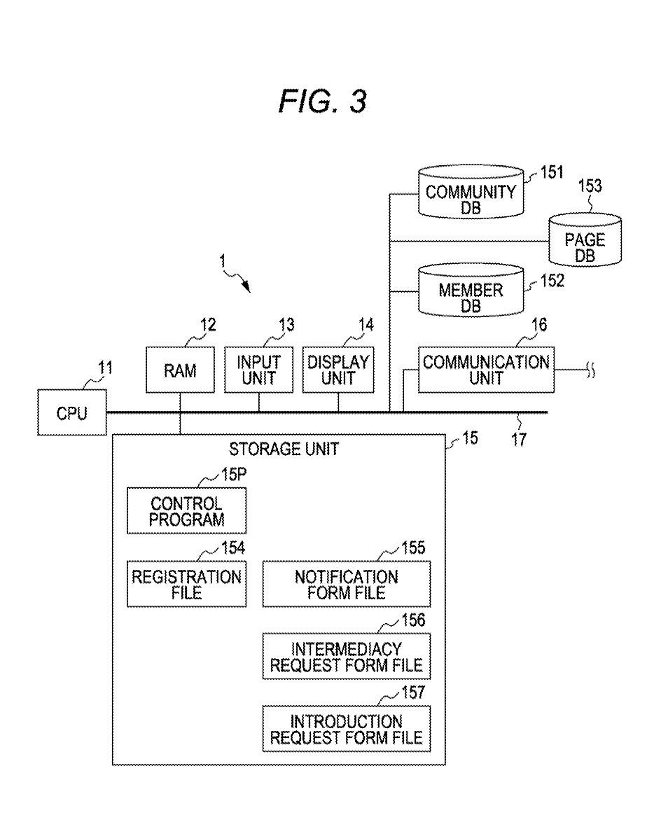

FIG. 3 is a block diagram showing a hardware configuration of the server computer 1. The server computer 1 is configured to include a CPU 11 serving as a control unit, a RAM 12, a communication unit 16, an input unit 13, a display unit 14, and a storage unit 15. The CPU 11 is connected to the other hardware constituent elements of the server computer 1 via a bus 17, respectively. The CPU 11 controls the other hardware constituent elements of the server computer 1 and executes various software functions according to a control program 15P stored in the storage unit 15.

The communication unit 16 is, for example, a gateway that functions as a firewall. The display unit 14 is, for example, a liquid crystal display. The input unit 13 is, for example, a keyboard and a mouse. The storage unit 15 is, for example, a hard disk. The storage unit 15 stores therein not only the control program 15P described above but also a registration file 154, a notification form file 155, an intermediacy request form file 156, and an introduction request form file 157. The CPU 11 executes various processes according to the control program 15P. A community database (hereinafter, “community DB”) 151, a member database (hereinafter, “member DB”) 152, and a page database (hereinafter, “page DB”) 153 are connected to the server computer 1. In the first embodiment, relational databases are employed as the respective databases. However, the type of the databases is not limited to the relational database but may be an arbitrary type.

The CPU 11 holds a dialog using an SQL (Structured Query Language: a language for operation of the relational databases according to ANSI standard and ISO standards) in a schema in which keys in fields of the community DB 151, the member DB 152, and the page DB 153 are associated with one another (i.e., the schema defines database structure and, if the databases are relational databases, defines data formats of items of tables and relations with the other tables). The CPU 11 executes processes such as storage and search of necessary information by the dialog. In the first embodiment, the community DB 151, the member DB 152, and the page DB 153 are stored in a database server (not shown) connected to the server computer 1. Alternatively, the community DB 151, the member DB 152, and the page DB 153 may be stored in the storage unit 15.

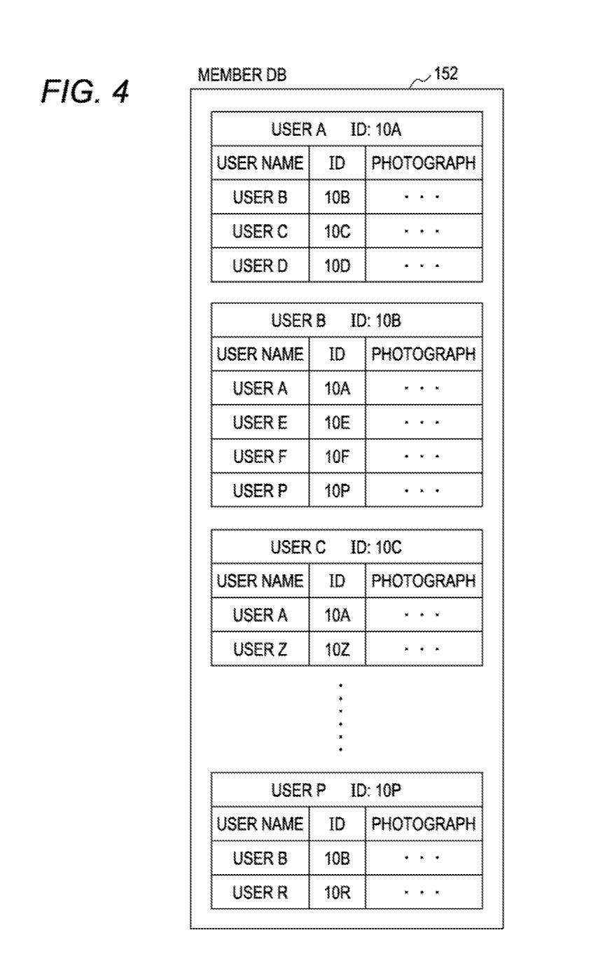

FIG. 4 is an explanatory diagram showing a record layout of the member DB 152. In the first embodiment, identification information characteristic of each user who is a member is assumed as a user name or a member number (hereinafter, “ID”) individually allocated to the user. Not only user names and user IDs of users but also user names and user IDs of friends of the users are stored in the member DB 152 so as to correspond to the respective users. For example, an ID of a user A is 10A, and a user B (ID: 10B), a user C (ID: 10C), and a user D (ID: 10D) are stored in the member DB 152 as friends of the user A. When a user A who is a member of the SNS wants to make a friendship with a user B who is a nonmember having a no ID in the SNS, the user A transmits a predetermined invitation to become a member of the SNS to the user B by an electronic mail. The user B clicks on a button included in the invitation to input acceptance to become a member of the SNS. The user A can make an established relationship with the user B in the SNS (i.e., the user B is registered as a friend of the user A in the SNS). Furthermore, if the users A and B are already members of the SNS, the user A transmits an electronic mail to the user B to request the user B to make the established relationship with the user A. If the user B clicks on a button including on the electronic mail to input acceptance to make the established relationship with the user A, the user A can make the established relationship with the user B.

If the friendship is made between the users A and B, the CPU 11 of the server computer 1 stores user names and user IDs of new friends of the respective users in the member DB 152. For example, the name and the ID of the user B are stored in the member DB 152 as those of a friend of the user A, and the name and the ID of the user A are stored therein as those of a friend of the user B. Furthermore, a user E (ID: 10E), a user F (ID: 10F), and a user P (ID: 10P) are stored in the member DB 152 as friends of the user B. Namely, the friend of the user A is the user B, whereas the users E, F, and P are the friends of the friend of the user A. In this case, the range of friends is two.

Moreover, a user R (ID: 10R) is stored in the member DB 152 as a friend, other than the user B, of the user P (ID: 10P). The user R is the friend of the friend of the friend of the user A. In this case, the range of friends is three. In this manner, it is seen that if the range is larger, the relation of the human network is poorer. In the first embodiment, the human network will be described, taking the user B who is the friend of the user A and the user R who is the friend of the user B as an example. In this example, no friendship is made between the users A and R yet.

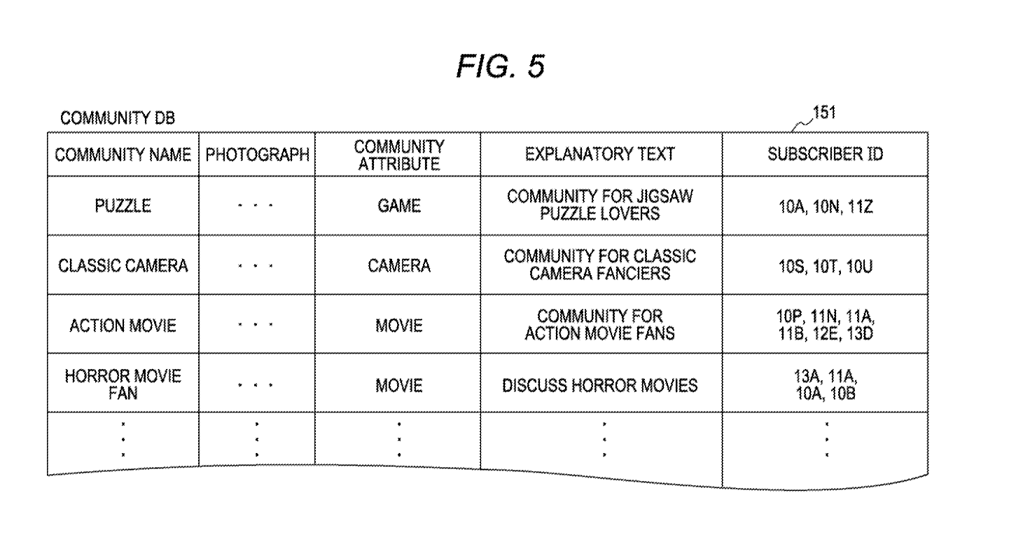

FIG. 5 is an explanatory diagram showing a record layout of the community DB 151. Community attributes and IDs of users participating in communities are stored in the community DB 151 so as to correspond to the respective communities. The community DB 151 includes community name fields, photograph fields, community attribute fields, explanatory text fields, and member ID fields. Names of a plurality of communities created by users are stored in the respective community name fields. For example, community in the name of puzzle community, classic camera community, action movie community, and horror movie fan community are stored in the respective community name fields.

Thumbnail images are stored in the photograph fields to correspond to the respective communities so as to be able to visually recognize the communities. Attributes for classifying the communities are stored in the community attribute fields to correspond to the respective community names. For example, the attribute of the community in the name of “puzzle” is “game”. The attribute of the community in the name “classic camera” is “camera”. The attributes of the communities in the name of “action movie” and “horror movie fan” are both “movie”.

Explanatory texts showing outlines of the communities are stored in the explanatory text fields to correspond to the respective community names. IDs of the users participating in the respective communities are stored in the member ID fields. For example, in the classic camera community, users whose IDs are respectively 10S, 10T, and 10U participate. It is also understood from FIG. 5 that the user A (ID: 10A) participates in the puzzle community and the horror movie fan community. In this example, it is assumed that the user A wants to participate in the classic camera community. In a present state, the ID 10A of the user A and the ID 10P of the user P who is the friends of the friend of the user A are not stored in the member ID field corresponding to the classic camera community.

An administrator who creates each community describes a page including contents of the name of the community, photograph data on the community, the attribute of the community, and the explanatory text of the community in HTML (Hyper Text Markup Language) using the personal computer 2 of the administrator. The administrator uploads the described contents from the personal computer 2 to the server computer 1. The CPU 11 of the server computer 1 stores the community name, the photograph data, the community attribute, and the explanatory text of the community in the community DB 151 on the basis of the uploaded contents. If the server computer 1 receives information indicating that users participate in communities from the personal computers 2 of the respective users with the IDs of the users, the server computer 1 accepts the IDs and sequentially stores the IDs of users in the member ID fields of the communities corresponding to the received information.

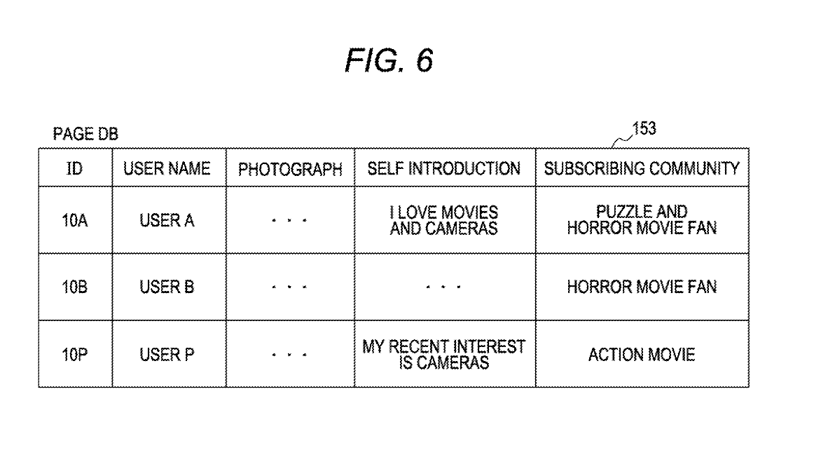

FIG. 6 is an explanatory diagram showing a record layout of the page DB 153. Various data constituting pages of the respective users are stored in the page DB 153. The page DB 153 includes ID fields, user name fields, photograph fields, self introduction fields, participating community fields and the like. Although data such as addresses, diaries, hobbies, and sexes are also stored in the page DB 153, those data will not be shown in FIG. 6 for convenience of description. IDs are stored in the ID fields and the user name fields corresponding to the respective user names. Further, thumbnail images for visually recognizing users are stored in the photograph fields to correspond to the respective user names.

Self introductions of users are stored in the self introduction fields to correspond to the respective user names. It is to be noted that the CPU 11 of the server computer 1 stores user names, photographs, self introductions and the like transmitted from the personal computers 2 of the respective users in the page DB 153 to correspond to the respective user IDs. Names of communities in which the respective users participate are stored in the participating community fields. For example, the user A participates in the puzzle community and the horror movie fan community. The CPU 11 of the server computer 1 searches the member ID fields in the community DB 151 on the basis of the ID of the user A stored in the page DB 153. The CPU 11 extracts the corresponding community names on the basis of the searched member ID fields. The CPU 11 stores the extracted community names in the participating community field corresponding to the user A in the page DB 153.

FIG. 7 is an explanatory diagram showing a displayed image of a top page. The example of FIG. 7 shows an image of a top page of the user A displayed by the browser 251 of the personal computer 2 of the user A. The CPU 11 of the server computer 1 performs the following processes to create data on this top page in an HTML form. First of all, the CPU 11 searches the member DB 152 on the basis of the ID of the user A and reads the user names and photograph data of the users who are friends of the user A. Moreover, the CPU 11 reads data such as the communities in which the user A participate and a diary of the user A while referring to the page DB 153. The CPU 11 reads the photograph data on the communities from the community DB 151 on the basis of the read community data.

The CPU 11 reads an HTML document template which is a base for generating the page data from the storage unit 15. The CPU 11 sets names of the friends of the user A, the photograph data on the friends, the communities, the photograph data on the communities and the like which are read from the member DB 152 or the page DB 153, to the read HTML document template to generate the page data. The CPU 11 transmits a generated HTML document to the personal computer 2 of the user A. As shown in FIG. 7, the diary of the user A, the friends of the user A, the communities in which the user A participates and the like are displayed. A NEW REGISTRATION button 241 is provided on the page as a button for executing an introduction process according to the first embodiment of the present invention. A hyperlink in HTML for transmitting information on an introduction process request for a request of executing the introduction process is described on the NEW REGISTRATION button 241. When the user A clicks on the NEW REGISTRATION button 241 via the input unit 23, the CPU 11 of the server computer 1 executes the following introduction process to the user A.

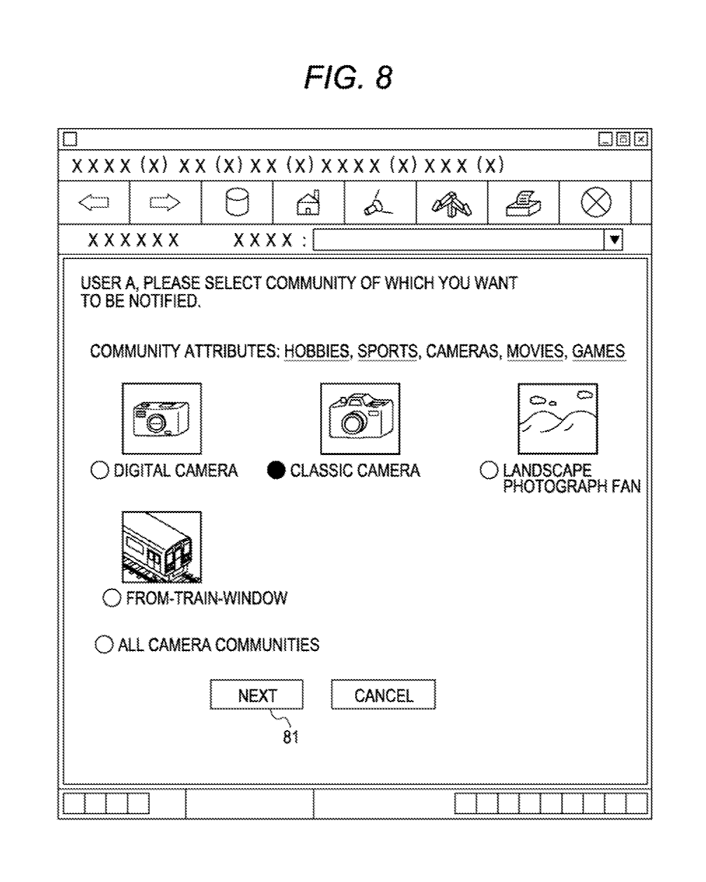

FIG. 8 is an explanatory diagram showing an image of a community registration screen. As the user A operates the NEW REGISTRATION button 241, the CPU 11 of the server computer 1 reads the community registration screen data from the storage unit 15 and transmits the community registration screen data to the personal computer 2 of the user A. The browser 251 of the personal computer 2 displays the community registration screen based on the community registration screen data upon a display device of the personal computer 2. When the user A designates the attribute of the community of which the user A wants to be notified via the input unit 23, icons of the communities according to the attribute are displayed upon the display device. The browser 251 displays the attributes of the communities on which hyperlinks are described and the icons of the communities corresponding to the respective community attributes. In the example of FIG. 8, the camera is selected as the attribute of communities, icons of the communities each having the camera as the attribute are displayed, and the user A selects the classic camera community as the community of which the user A wants to be notified.

Moreover, the community can be selected not only by directly selecting the community name of the community but also by selecting the attribute of community. For example, if the user A wants to select all the communities having the camera that is one of the attributes of the communities, the user selects “ALL CAMERA COMMUNITIES” via the input unit 3. In this case, all the communities including a digital camera community, the classic camera community, a landscape photograph fan community, and a from-train-window community are selected. In this way, every user selects the community or communities and the attribute of the community or communities via the input unit 23 as information on the community or communities of which the user wants to be notified. A hyperlink that is a trigger to transmit the information on the community or communities and the ID of the user to the server computer 1 is described on a NEXT button 81.

If the user clicks on the NEXT button 81 via the input unit 23, the CPU 21 of the personal computer 2 transmits the information on the selected community or communities to the server computer 1 so as to correspond to the ID of the user. In the example shown in FIG. 8, the user A selects the classic camera community and the CPU 21 of the personal computer 2 of the user A transmits the information on the classic camera community to the server computer 1 so as to correspond to the ID of the user A. The CPU 11 of the server computer 1 receives the transmitted information on the classic camera community and the ID of the user A.

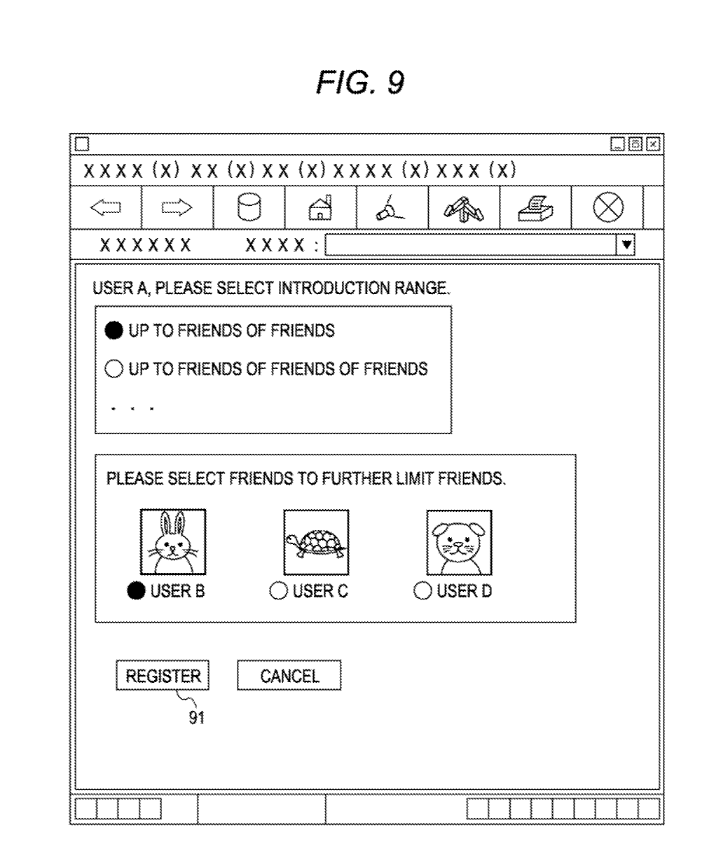

FIG. 9 is an explanatory diagram showing an image at the time of deciding an introduction range. In the example shown in FIG. 9, if receiving the information on the community, the CPU 11 of the server computer 1 reads an introduction range registration screen shown in FIG. 9 from the storage unit 15 and transmits the introduction range registration screen to the personal computer 2 of the user A. The introduction range registration screen shown in FIG. 9 is displayed by the browser 251 of the personal computer 2. The user A who wants to be introduced inputs an introduction range up to users to whom the user A is introduced via the input unit 23. If the user A selects “up to friends of friends” as a selection item on the introduction range registration screen, the introduction range is two, so that the introduction range is set up to friends of the respective users B, C, and D who are the friends of the user A.

Moreover, if the user A selects “up to friends of friends of friends” as a selection item, the introduction range is three, so that the introduction range is set up to friends of friends of the respective users B, C, and D who are the friends of the user A. In the first embodiment, the selection items such as “friends of friends” are described so as to be able to intuitively understand the introduction range. Alternatively, each user may be allowed to input, for example, the number as the introduction range from the input unit 23. In case of the “friends of friends”, the user inputs 2 as the introduction range. In case of the “friends of friends of friends”, the user inputs 3 as the introduction range.

In the example of FIG. 9, the selection item “up to friends of friends” is selected. For the setting of the introduction range, the introduction range can be restricted by further designating friends. For example, among a plurality of friends, the user A can designate more reliable friends via the input unit 23. In the example of FIG. 9, the user B is selected from among the users B, C, and D who are the friends of the user A. By doing so, the introduction range is up to users E, F, and P who are the friends of the user B who is the friend of the user A (see FIG. 4).

A REGISTER button 91 is provided on the introduction range registration screen. A hyperlink for transmitting the ID of the user A and the introduction range input via the input unit 23 to the server computer 1 is described on the REGISTER button 91. If the user A clicks on the REGISTER button 91 via the input unit 23, the CPU 21 of the personal computer 2 of the user A transmits the introduction range to the server computer 1 so as to correspond to the ID of the user A. The CPU 11 of the server computer 1 receives the transmitted introduction range with the ID of the user A, and stores the introduction range and the ID of the user A in the RAM 12.

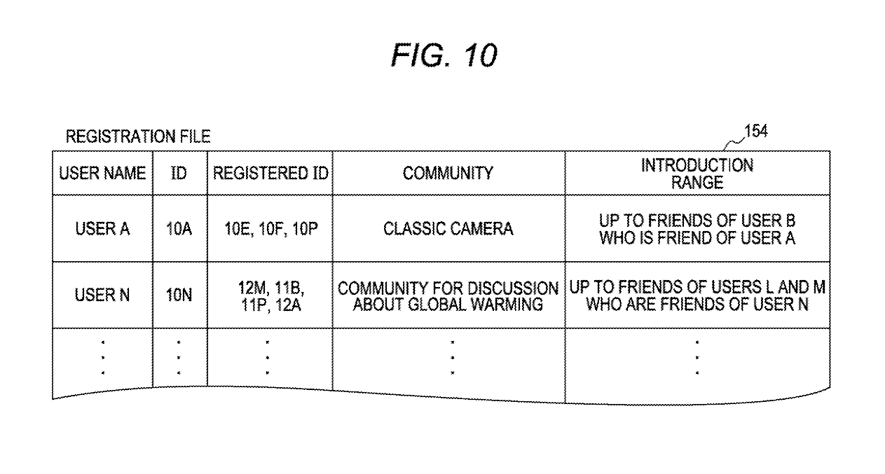

FIG. 10 is an explanatory diagram showing a record layout of the registration file 154. The registration file 154 stores therein introduction ranges designated by the users through the introduction process and communities to correspond to the respective users. The registration file 154 includes user name fields, ID fields, registered ID fields, community fields, and introduction range fields. The name of the user who executes the introduction process is stored in each of the user name fields, and the ID corresponding to the user name is stored in each of the ID fields. The above-stated introduction range is stored in each of the introduction range fields to correspond to the ID of the user who executes the introduction process. In the above-stated example, “up to friends of the user B who is the friend of the user A” is stored in the introduction range field corresponding to the user A as the introduction range transmitted from the user A. The CPU 11 of the server computer 1 performs the following processes if information on the introduction range and the communities are transmitted from the personal computer 2 of each user to correspond to the ID of the user.

If the CPU 11 receives the introduction range corresponding to the ID of the user, the CPU 11 extracts IDs of the other users who are included within the introduction range by referring to the member DB 152. Further, the CPU 11 performs a process for excluding the received ID and the IDs of the other users who are already friends of the user corresponding to the received ID among the extracted IDs. The CPU 11 stores the IDs after the exclusion process in the registered ID field corresponding to the received ID in the registration file 154 as monitoring targets. For example, if the introduction range is “up to friends of the user B who is the friend of the user A”, the CPU 11 searches the member DB 152 on the basis of the ID of the user A and extracts the ID of the user B. Furthermore, the CPU 11 searches the member DB 152 on the basis of the extracted ID of the user B and extracts IDs of the users A, E, F, and P.

The CPU 11 performs the process for excluding IDs of which the other user is unnecessary to be introduced, i.e., the ID of the user A himself or herself and the ID of the user B who is already the friend of the user A among the extracted IDs. As a result, the CPU 11 finally extracts 10E, 10F, and 10P that are IDs of the other users E, F, and P. The CPU 11 stores these extracted IDs in the registered ID field corresponding to the user A in the registration file 154 as monitoring targets.

If the CPU 11 receives the community and the ID from the personal computer 2 of each user, the CPU 11 stores the received community in the community field corresponding to the user in the registration file 154 so as to correspond to the received ID. As shown in FIG. 10, in relation to the user A, the CPU 11 monitors whether or not the users E, F, and P participate in the classic camera community. The CPU 11 monitors the member ID field corresponding to the classic camera community in the community DB 151. If 10E, 10F, and 10P that are registered IDs are stored in the member ID field corresponding to the classic camera community in the community DB 151, the CPU 11 performs the following notification process.

In the present embodiment, the notification process will be described while the monitoring target user P participates in the classic camera community as an example. The CPU 11 of the server computer 1 searches the community DB 151 on the basis of both the community and the registered IDs stored in the registration file 154. If the registered ID has been stored in the member ID field corresponding to the community, then the CPU 11 reads the notification form file 155 and transmits a notification form to the personal computer 2 of the user corresponding to the stored registered ID.

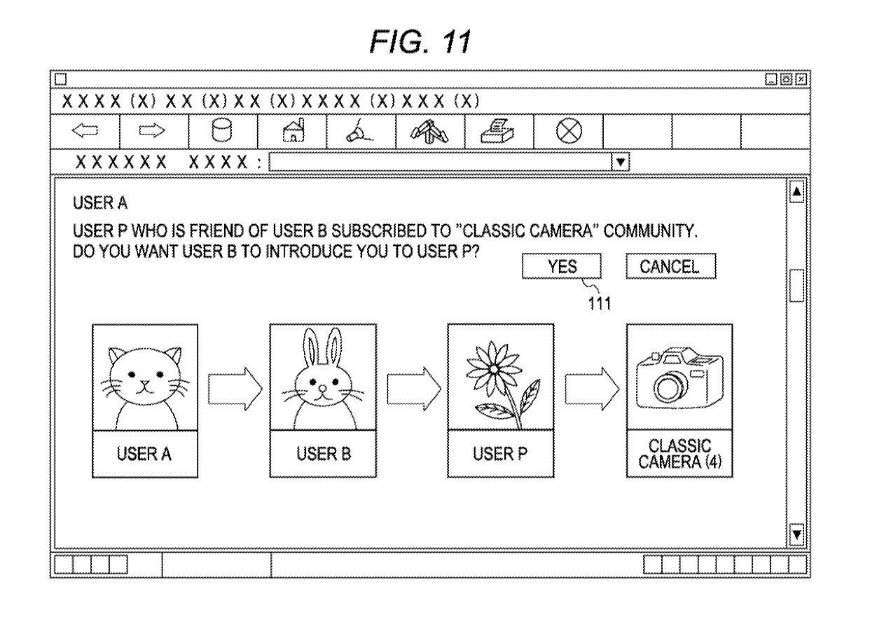

FIG. 11 is an explanatory diagram showing an image of the notification form. A procedure as to through which intermediary user, an introduction target user participated in the registered community is visually recognizably described on the notification form. In the example of FIG. 11, a name and a photograph of the user A who wants to be introduced to the user P are displayed on the left, and a name and a photograph of the user B who is the friend of the user A and who serves as an intermediary user are displayed next to the photograph of the user A across a right arrow indicating a request. A name and a photograph of the user P who is the friend of the user B and who serves as an introduction target are displayed next to the photograph of the user B across a right arrow indicating a request. By so displaying, it is possible to easily visually recognize through what human network the introduction process proceeds.

Moreover, an icon indicating the classic camera community that is a name and a photograph of the classic camera community in which the user P newly participated are displayed in the right of the user P across a right arrow indicating participation. Further, a sentence of a request that the intermediary user B introduce the user A to the introduction target user P is written on an upper side of the notification form data. The CPU 11 of the server computer 1 writes user names and the community on the read notification form data and then transmits the notification form data to the personal computer 2 of the user A.

A YES button 111 is provided on the notification form data. If the user A clicks on the YES button 111 via the input unit 23, information on the introduction request is transmitted to the server computer 1. A hyperlink is described in definition of the YES button 111. If a user clicks on the YES button 111, the CPU 21 of the personal computer 2 transmits the ID of the user and the information on the introduction request to the server computer 1.

The CPU 11 of the server computer 1 reads an intermediacy request form from the intermediacy request form file 156 on the basis of the transmitted introduction request. The intermediacy request form is a form of an intermediacy request made for the personal computer 2 corresponding to the ID of the user who wants to be introduced, with the ID or name of the intermediary user set as a destination. In the example of FIG. 11, an intermediacy request form with the intermediary user B set to a destination is created for the personal computer 2 of the user A who wants to be introduced to the user P. This is a form in which the user A asks the intermediary user B to introduce the user A to the introduction target user P.

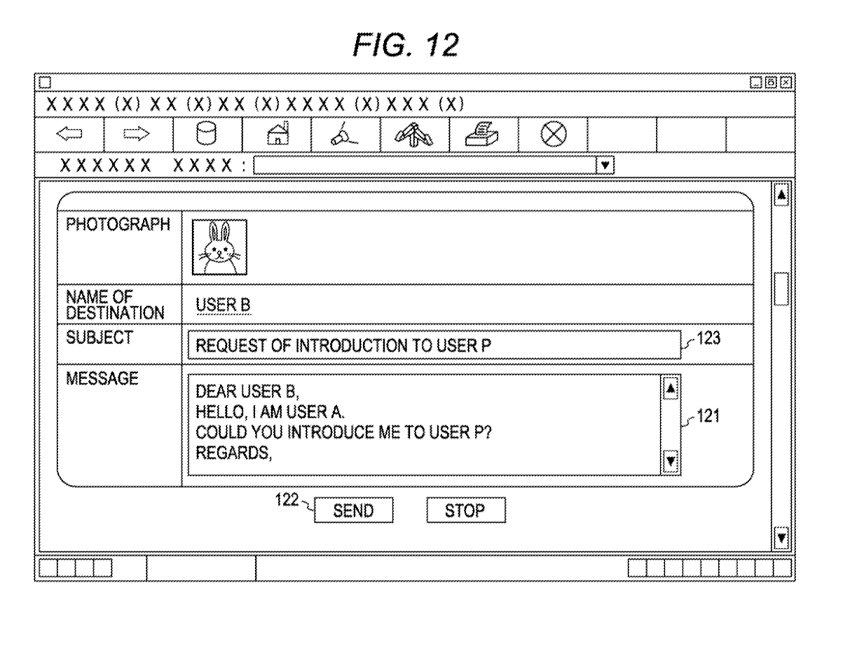

FIG. 12 is an explanatory diagram showing an image of the intermediacy request form. The photograph and name of the intermediary user B are displayed on the intermediacy request form. A hyperlink is set to the name of the user B. The ID of the user B for acquiring information on the user B is described in the hyperlink. As a subject, “request of introduction to user P” who is the introduction target user is written. The user A writes an appropriate message in a message box 121 via the input unit 23. The CPU 11 of the server computer 1 reads the intermediacy request form from the intermediacy request form file 156, the photograph data, the name, and the ID of the intermediary user B from the member DB 152. And the CPU 11 writes them in the intermediacy request form, writes the subject mentioning the name of the user P in a subject box 123. And then, the CPU 11 transmits the written intermediacy request form to the personal computer 2 of the user A.

If the user A clicks on a SEND button 122 shown in FIG. 12 via the input unit 23, the ID of the user B and the intermediacy request form in which the ID of the user B is set as the destination are transmitted to the server computer 1. The CPU 11 of the server computer 1 stores both the ID of the user B and the intermediacy request form transmitted from the personal computer 2 of the user A in the storage unit 15. If the user B logs in, the CPU 11 reads the stored intermediacy request form. Further, the CPU 11 transmits the read intermediacy request form to the personal computer 2 of the user B with the user A set to a sender.

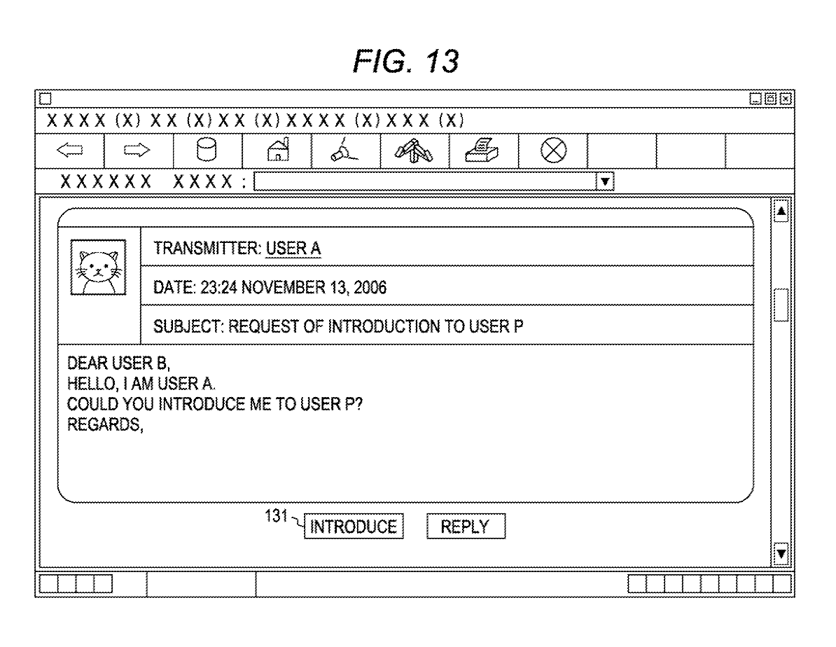

FIG. 13 is an explanatory diagram showing a displayed image of the intermediacy request message. The browser 251 of the personal computer 2 of the user B displays the intermediacy request message transmitted from the personal computer 2 of the user A. When the user B saw the intermediacy request message, the user B recognizes that the user B is asked to introduce the user A to the user P who is the friend of the user B. An INTRODUCE button 131 is displayed on the intermediacy request message. If the user B is to execute an introduction, the user B clicks on the INTRODUCE button 131 via the input unit 23. As a result, information on the request of introduction of the user A to the user P is transmitted from the personal computer 2 of the user B to the server computer 1.

If the CPU 11 of the server computer 1 receives the information on the introduction request transmitted from the personal computer 2 of the user B, the CPU 11 reads an introduction request form from the introduction request form file 157. This introduction request form is a form which is created for the personal computer 2 corresponding to the ID of the intermediary user B and in which the ID or name of the introduction target user P is written as a destination.

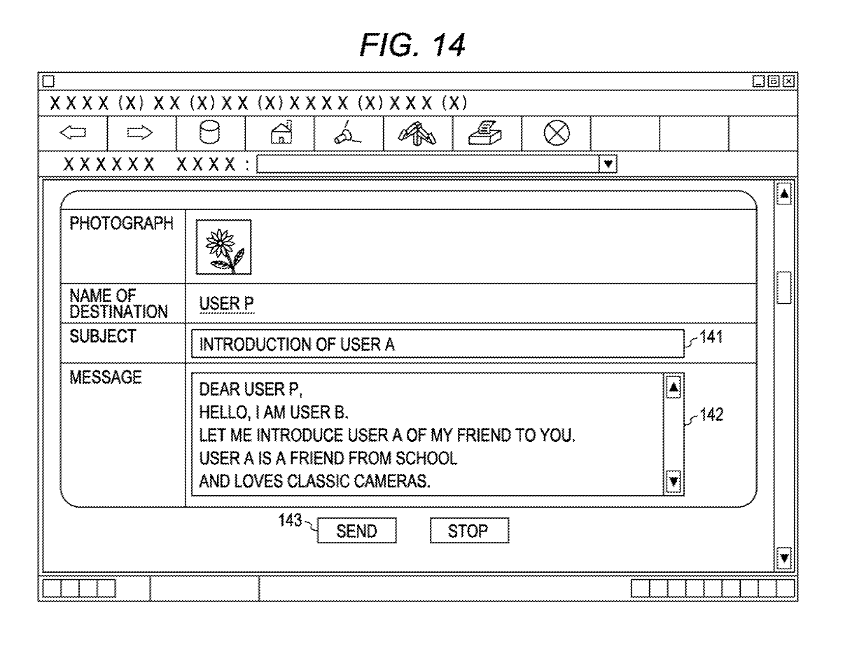

FIG. 14 is an explanatory diagram showing a displayed image of the introduction request form. The photograph and the name of the user P who is the introduction target user are displayed on the introduction request form. A hyperlink is set to the name of the user P. The ID of the user P for acquiring information on the user P is described on the hyperlink. A subject mentioning “introduction of user A” who is the user who wants to be introduced to the user P is written in a subject box 141. The intermediary user B writes an appropriate message in a message box 142 via the input unit 23. The CPU 11 of the server computer 1 reads the introduction request form from the introduction request form file 157. The CPU 11 reads the photograph data, the name, and the ID of the user P to whom the user A wants to be introduced from the member DB 152. And the CPU 11 writes them in the introduction request form, and further writes the subject mentioning the name of the user A. Thereafter, the CPU 11 transmits the written introduction request form to the personal computer 2 of the user B.

If the user B clicks on a SEND button 143 shown in FIG. 14 via the input unit 23, the ID of the user P and the introduction request form in which the ID of the user P is set as a destination are transmitted to the server computer 1. The CPU 11 of the server computer 1 stores both the ID of the user P and the introduction request form transmitted from the personal computer 2 of the user B in the storage unit 15. If the user P logs in, the CPU 11 reads the stored introduction request form. Further, the CPU 11 transmits the read introduction request form to the personal computer 2 of the user P with both the user B set as a transmitter and the user A set to the user who wants to be introduced.

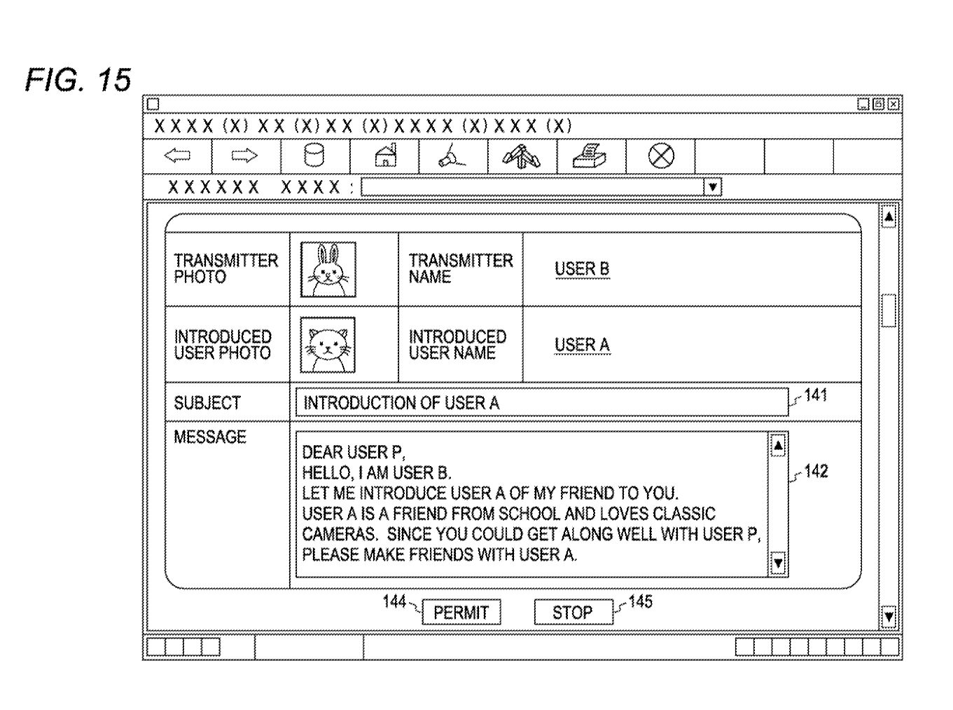

FIG. 15 is an explanatory diagram showing a displayed image of an introduction request message. The browser 251 of the user P displays the introduction request message transmitted from the personal computer 2 of the user B who is the transmitter. The user P recognizes that the user B who is the friend of the user P wants to introduce the user A who is the friend of the user B to the user P. A PERMIT button 144 and a STOP button 145 are displayed on the introduction request message. If the user P permits introduction of the user A, the user P clicks on the PERMIT button 144 via the input unit 23. If the user P does not permit introduction of the user A, the user P clicks on the STOP button 145 via the input unit 23. If the user P clicks on the PERMIT button 144 via the input unit 23, information indicating a permission to introduce the user A to the user P via the user B is transmitted from the personal computer 2 of the user P to the server computer 1.

If the CPU 11 of the server computer 1 receives the information on the permission of introduction, the CPU 11 makes a setting to make a friendship between the users A and P. The CPU 11 stores the name, the ID, and the photograph data of the user P in a storage region corresponding to the user A in the member DB 152. Moreover, the CPU 11 stores the name, the ID, and the photograph data of the user A in a storage region corresponding to the user P in the member DB 152.

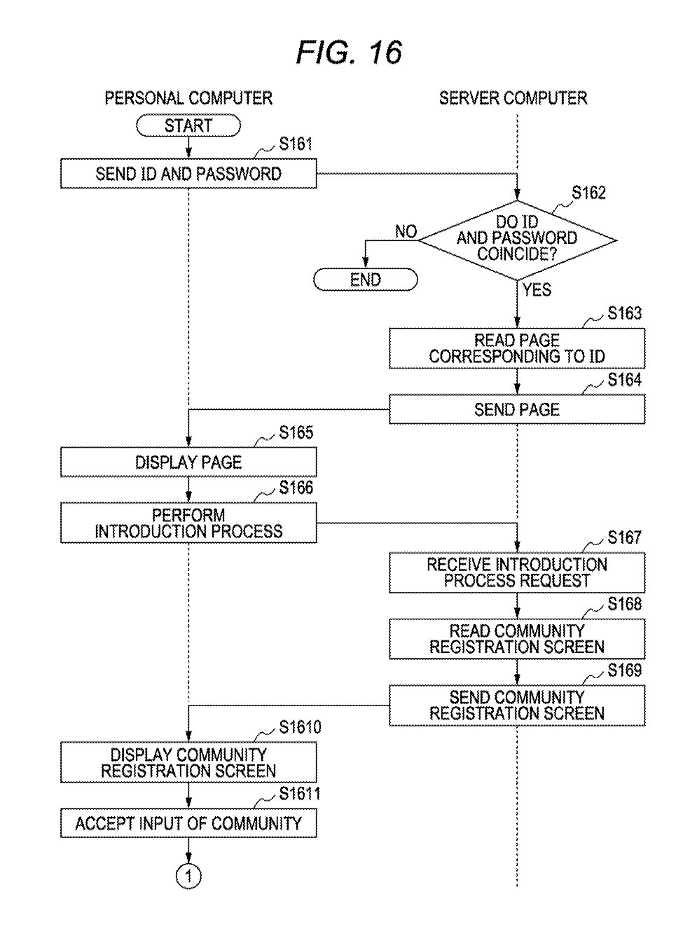

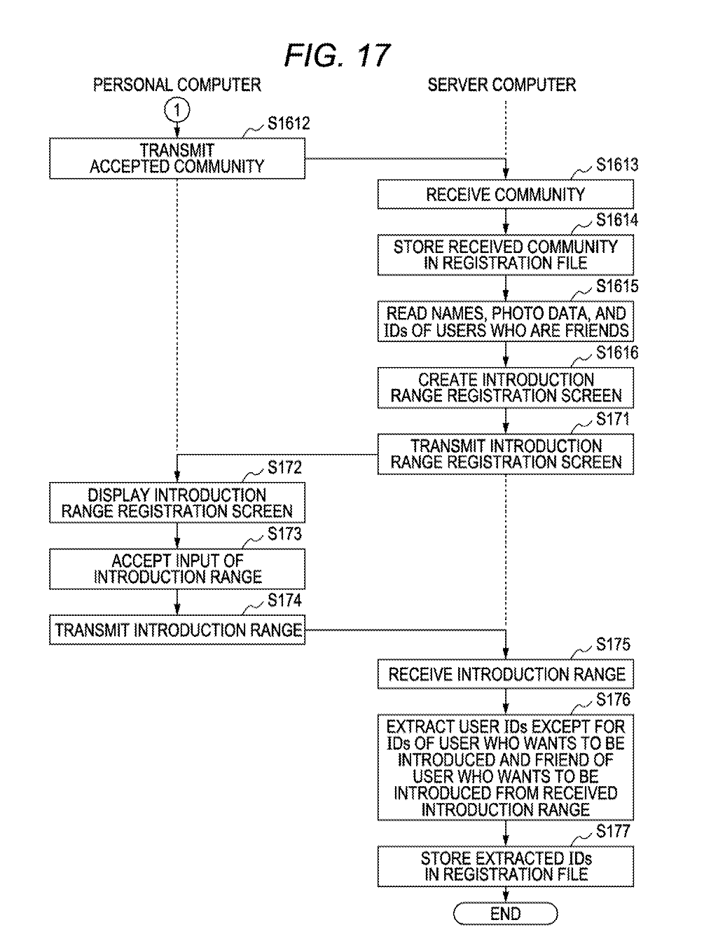

The introduction range registration process performed by the introduction supporting apparatus including the above-stated hardware configuration according to the first embodiment will be described with reference to operation flows. FIGS. 16 and 17 are operation flows showing procedures of the introduction range registration process. The user who wants to be introduced to the introduction target user (i.e., user A in the above-stated example) starts the browser 251 on the personal computer 2, and inputs a URL for an access to the server computer 1 via the input unit 23. Further, the user inputs the ID and the password of the user for login via the input unit 23. The CPU 21 of the personal computer 2 of the user accepts the input ID and the password, and transmits the ID and the password of the user to the server computer 1 via the communication unit 26 (operation S161).

The CPU 11 of the server computer 1 receives the ID and the password transmitted from the personal computer 2 of the user, and determines whether the ID and the password coincide with those stored in the storage unit 15 in advance (operation S162). If the CPU 11 determines that the ID and the password do not coincide with those stored in the storage unit 15 (NO, operation S162), then the CPU 11 determines that the ID and the password were transmitted by an illegal access. And the CPU 11 finishes a series of the process. If the CPU 11 determines that the transmitted ID and password coincide with those stored in the storage unit 15 (YES, operation S162), then the CPU 11 permits the user who inputted the transmitted ID to log in the SNS. And the CPU 11 reads the page of the user corresponding to the transmitted ID from the page DB 153 while referring to the page DB 153 (operation S163). Further, the CPU 11 creates an HTML document based on the read user data, and transmits the created page to the personal computer 2 of the user (operation S164).

If the personal computer 2 of the user receives the page created by the CPU 11 of the server computer 1, the personal computer 2 of the user causes the browser 251 to display the page shown in FIG. 7 (operation S165). If the NEW REGISTRATION button 241 shown in FIG. 7 is clicked on via the input unit 23, the CPU 21 of the personal computer 2 of the user transmits information on a request of a new introduction process to the server computer 1 (operation S166). The CPU 11 of the server computer 1 receives the information on the request of the new introduction process transmitted from the CPU 21 of the personal computer 2 of the user (operation S167).

The CPU 11 reads communities and image data corresponding to each attribute of communities from the community DB 151 shown in FIG. 5. Further, the CPU 11 reads an HTML document which is a base to create the community registration screen from the storage unit 15 (operation S168). The CPU 11 additionally writes information including the communities and the photograph data corresponding to each attribute read from the community DB 151 in the HTML document, and the CPU 11 thereby creates the community registration screen. The CPU 11 transmits the created community registration screen to the personal computer 2 of the user who wants to be introduced via the communication unit 16 (operation S169).

The CPU 21 of the personal computer 2 of the user who wants to be introduced causes the browser 251 to display the community registration screen as shown in FIG. 8 (operation S1610). The CPU 21 accepts input of information on the community in which the user is to be registered via the input unit 23 (operation S1611). As already stated, the accepted information on the community may include the attribute of the communities other than names of one or a plurality of communities. The CPU 21 transmits the accepted information on the community to the server computer 1 (operation S1612).

The CPU 11 of the server computer 1 receives the information on the community transmitted from the CPU 21 of the personal computer 2 of the user who wants to be introduced (operation S1613). The CPU 11 stores the received information on the community in the registration file 154 as a monitoring target so as to correspond to the ID of the user who wants to be introduced (operation S1614).

The CPU 11 reads the names, the photograph data, and the IDs of the users who are the friends of the user who wants to be introduced from the member DB 152 (operation S1615). The CPU 11 reads data on the created introduction registration screen from the storage unit 15. Further, the CPU 11 writes the names, the photograph data, and the IDs of the users who are the friends of the user who wants to be introduced read in the operation S1615 in the HTML document, and the CPU 11 thereby creates the introduction registration screen shown in FIG. 9 (operation S1616). The CPU 11 transmits the introduction registration screen in the HTML form to the personal computer 2 of the user who wants to be introduced via the communication unit 16 (operation S171).

The CPU 21 of the personal computer 2 of the user who wants to be introduced causes the browser 251 to display the introduction registration screen transmitted from the server computer 1 (operation S172). As stated above, the user inputs the introduction range via the input unit 23. The CPU 21 accepts input of the introduction range via the input unit 23 (operation S173). The CPU 21 transmits the accepted introduction range to the server computer 1 (operation S174). The CPU 11 of the server computer 1 receives the introduction range transmitted from the personal computer 2 (operation S175). Further, the CPU 11 stores the introduction range received in the operation S175 to correspond to the ID of the user A. Next, the CPU 11 searches the member DB 152 on the basis of the introduction range received in the operation S175, and the CPU 11 extracts the IDs of the users who is included within the introduction range up to the user to whom the user A wants to be introduced. The CPU 11 extracts the user IDs except for the IDs of the user A and the user B who is the friend of the user A from among the extracted IDs so as to select monitoring targets (operation S176). The CPU 11 stores the extracted IDs in the registration file 154 to correspond both to the ID of the user who wants to be introduced and to the community stored in the operation S1614 (operation S177).

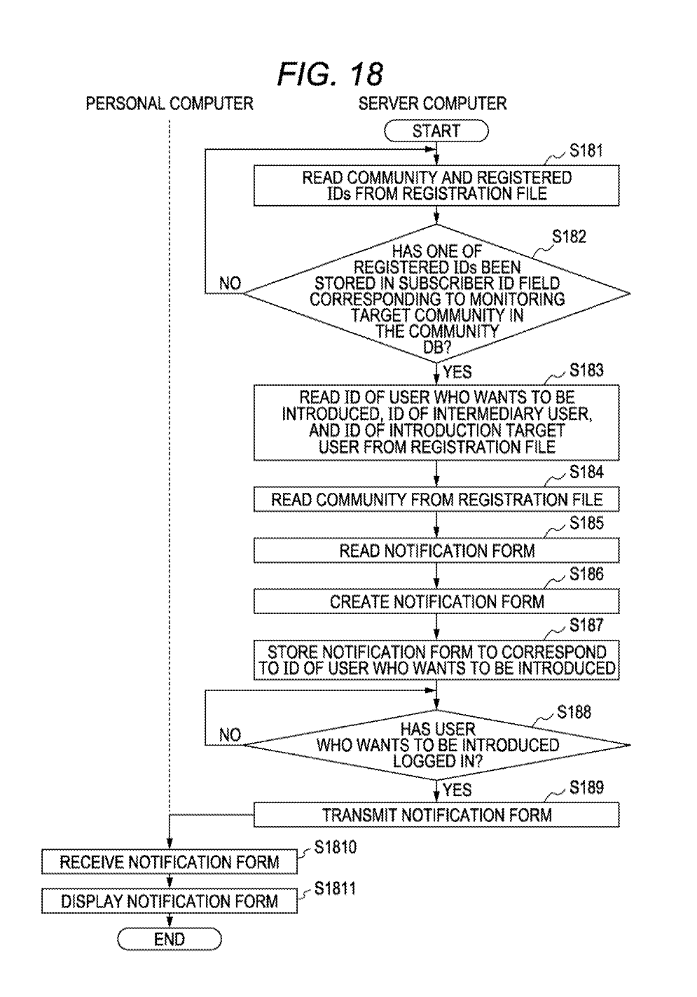

FIG. 18 is an operation flow showing procedures of the notification process. The CPU 11 of the server computer 1 reads both the community and the registered IDs corresponding to the community as monitoring targets from the registration file 154 (operation S181). In the above-stated example, the community is the classic camera community and the registered IDs are 10E, 10F, and 10P. The CPU 11 determines whether one of the monitoring target registered IDs has been stored in the member ID field corresponding to the monitoring target community in the community DB 151 while the CPU 11 refers to the community DB 151 (operation S182). If the CPU 11 determines that one of the monitoring target registered IDs has not been stored (NO; operation S182), the process goes to an operation S181 and the above-stated procedures are repeated.

On the other hand, if the CPU 11 determines that one of the monitoring target registered IDs has been newly stored in the member ID field corresponding to the monitoring target community (YES; operation S182), the CPU 11 reads three IDs which are stored in the ID field. The three IDs are the ID of the user who wants to be introduced, the ID of the intermediary user who is included within the introduction range received in the operation S175, and the ID of the user that is newly registered and that corresponds to the introduction target user from the registration file 154 (operation S183). The CPU 11 reads the community in which the introduction target user participates from registration file 154 (operation S184). Moreover, the CPU 11 reads the photograph data on the user who wants to be introduced, the intermediary user, the introduction target user, and the community from the member DB 152 or the page DB 153.

The CPU 11 reads a notification form from the notification form file 155 (operation S185). The CPU 11 writes information on the user and photograph data corresponding to the information in the notification form. The user is the user who wants to be introduced, the intermediary user, and the introduction target user. The CPU 11 thereby creates the notification form shown in FIG. 11 (operation S186). The CPU 11 stores the created notification form in the notification form file 155 to correspond to the ID of the user who wants to be introduced (operation S187). In the example, the CPU 11 stores the notification form created to correspond to the ID of the user A in the notification form file 155.

The CPU 11 determines whether the user who wants to be introduced has logged in (operation S188). If the CPU 11 determines that the user who wants to be introduced has not logged in (NO; operation S188), the same procedures are repeated. If the CPU 11 determines that the user who wants to be introduced has logged in (YES; operation S188), the CPU 11 reads the created notification form corresponding to the login user from the notification form file 155, and transmits the notification form to the personal computer 2 of the login user (operation S189). The CPU 21 of the personal computer 2 receives the notification form transmitted from the server computer 1 (operation S1810), and causes the browser 251 to display the notification form as shown in FIG. 11 (operation S1811).

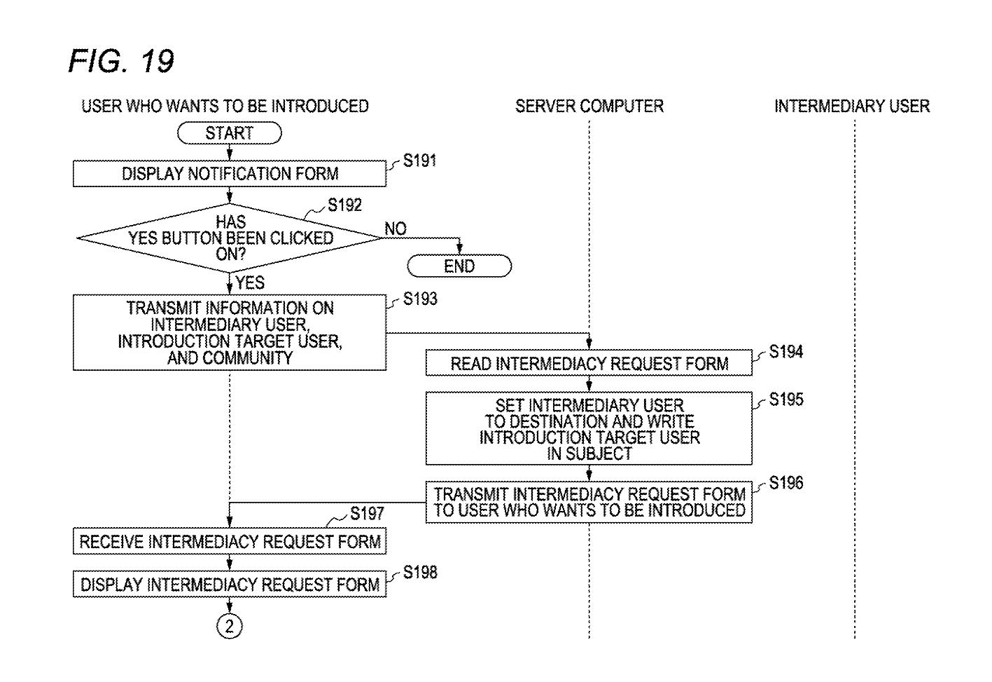

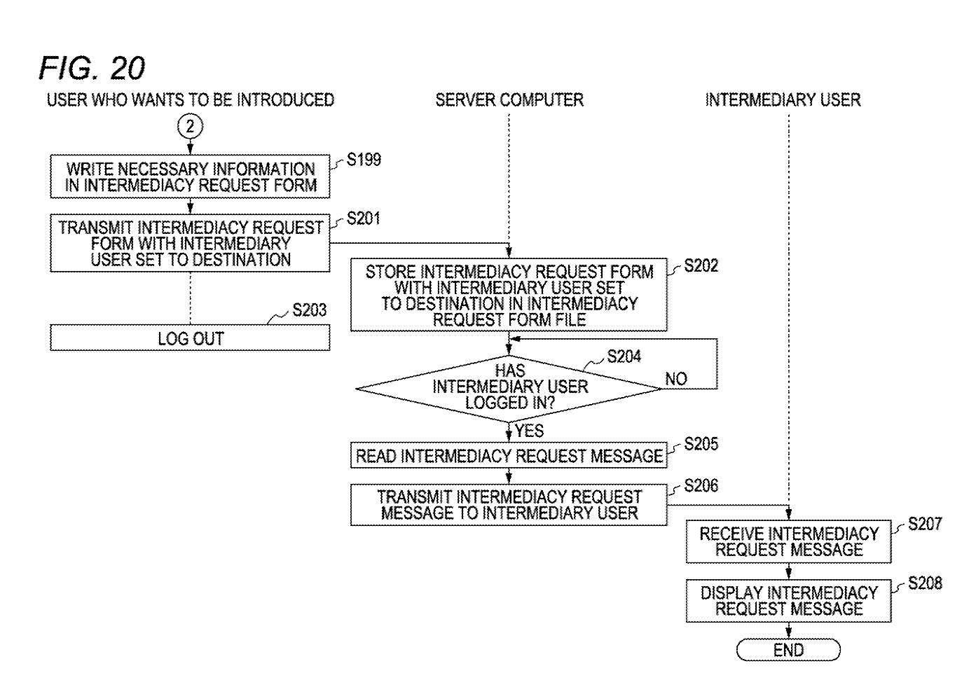

FIGS. 19 and 20 are operation flows showing procedures of the intermediacy process. The CPU 21 of the personal computer 2 of the user who wants to be introduced causes the browser 251 to display the notification form as shown in FIG. 11 similarly to the operation S1811 (operation S191). The CPU 21 determines whether the YES button 111 serving as a trigger to proceed with the following intermediacy process has been clicked on via the input unit 23 (operation S192). If the CPU 11 determines that the YES button 111 has not been clicked on (i.e., a CANCEL button has been clicked on) (NO; operation S192), the CPU 11 determines that intermediacy is unnecessary and finishes a series of the process.

On the other hand, if the CPU 11 determines that the YES button 111 has been clicked on (YES; operation S192), the CPU 11 transmits information on the intermediary user, the introduction target user, and the community to the server computer 1 (operation S193). In this example, the information on the intermediary user B, the introduction target user P, and the classic camera community is transmitted from the personal computer 2 of the user A to the server computer 1. The CPU 11 of the server computer 1 receives the transmitted information and reads an intermediacy request form from the intermediacy request form file 156 (operation S194).

The CPU 11 sets the intermediary user to a destination, additionally writes the subject mentioning the name of the introduction target user in the subject box 123 on the intermediacy request form read in the operation S194 (operation S195), and transmits the intermediacy request form to the personal computer 2 of the user who wants to be introduced (operation S196). The CPU 21 of the personal computer 2 of the user who wants to be introduced receives the intermediacy request form (operation S197). The CPU 21 causes the browser 251 to display the intermediacy request form shown in FIG. 12 (operation S198). The user who wants to be introduced writes necessary information in the message box 121 via the input unit 23 (operation S199).

The CPU 21 accepts the information that the user who wants to be introduced inputted via the input unit 23 and added to the intermediacy request form. The CPU 21 transmits the intermediacy request form in which the ID of the intermediary user is set as a destination to the server computer 1 in response to click-on of the SEND button by the user who wants to be introduced (i.e., the user A in this example) shown in FIG. 12 as a trigger (operation S201). The CPU 11 of the server computer 1 stores the intermediacy request form with the ID of the intermediary user (i.e., the user B in this example) set to the destination in the intermediacy request form file 156 (operation S202). Thereafter, the user who wants to be introduced logs out (operation S203).

The CPU 11 of the server computer 1 determines whether the intermediary user has logged in (operation S204). If the CPU 11 determines that the intermediary user has not logged in (NO; operation S204), the CPU 11 repeats the same procedure until the intermediary user logs in. On the other hand, if the CPU 11 determines that the intermediary user has logged in (YES; operation S204), the CPU 11 reads the intermediacy request form in which the intermediary user set to the destination and which form is stored in the operation S202 (operation S205). The CPU 11 reads the name and the photograph data of the user who wants to be introduced (i.e., the user A in this example) from the member DB 152, adds the intermediacy request message to the intermediacy request form, and transmits the intermediacy request form to the personal computer 2 of the intermediary user (operation S206). The CPU 21 of the personal computer 2 of the intermediary user receives the intermediacy request form transmitted from the server computer 1 (operation S207), and causes the browser 251 to display the received intermediacy request form as shown in FIG. 13 (operation S208).

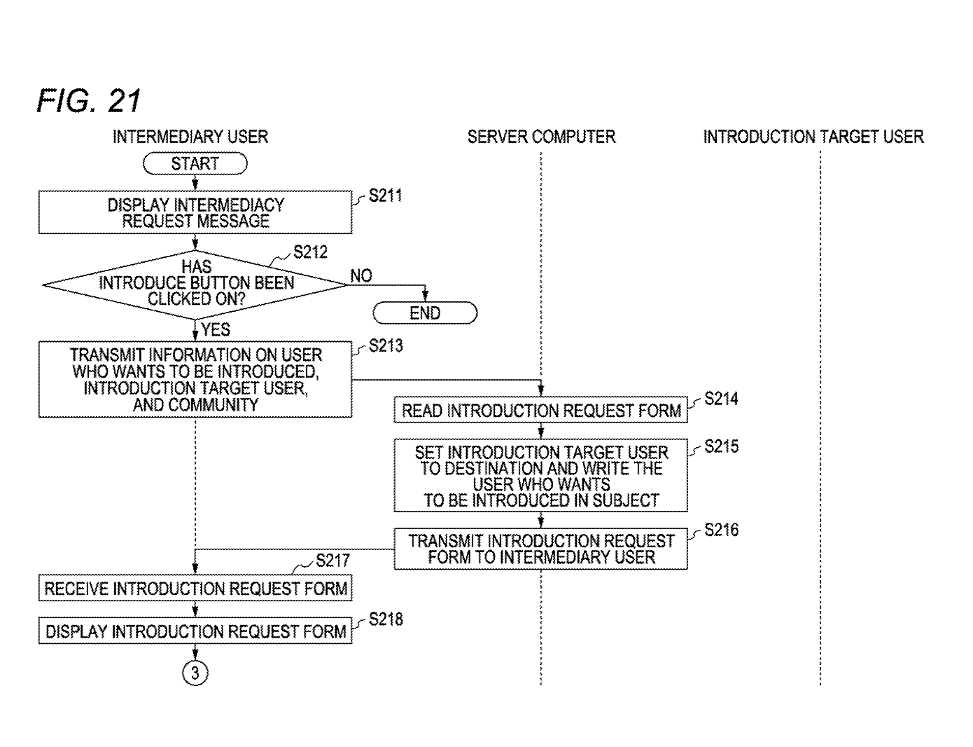

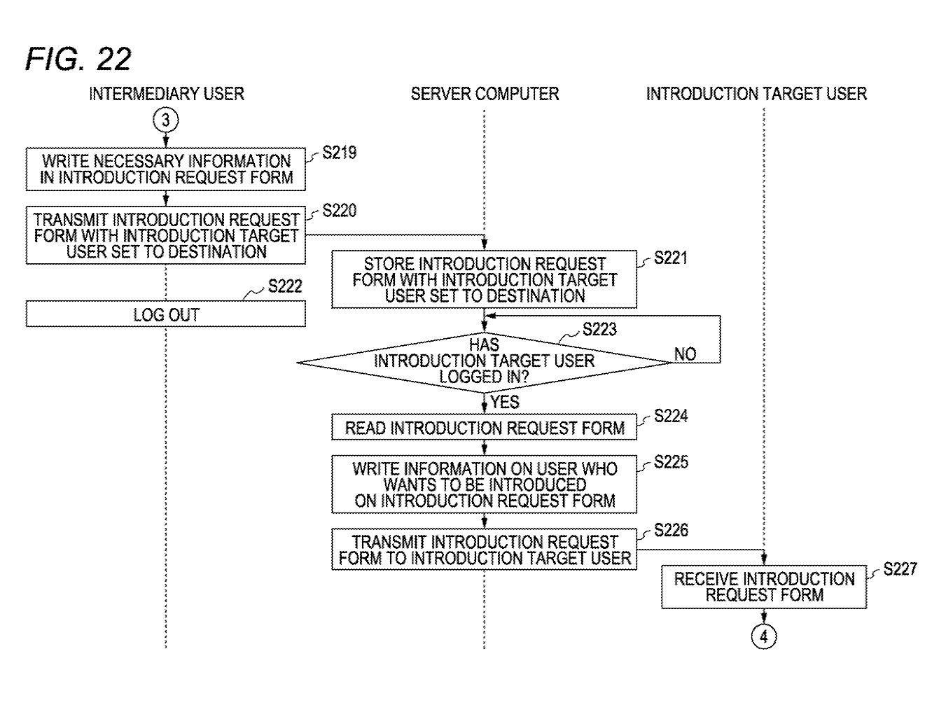

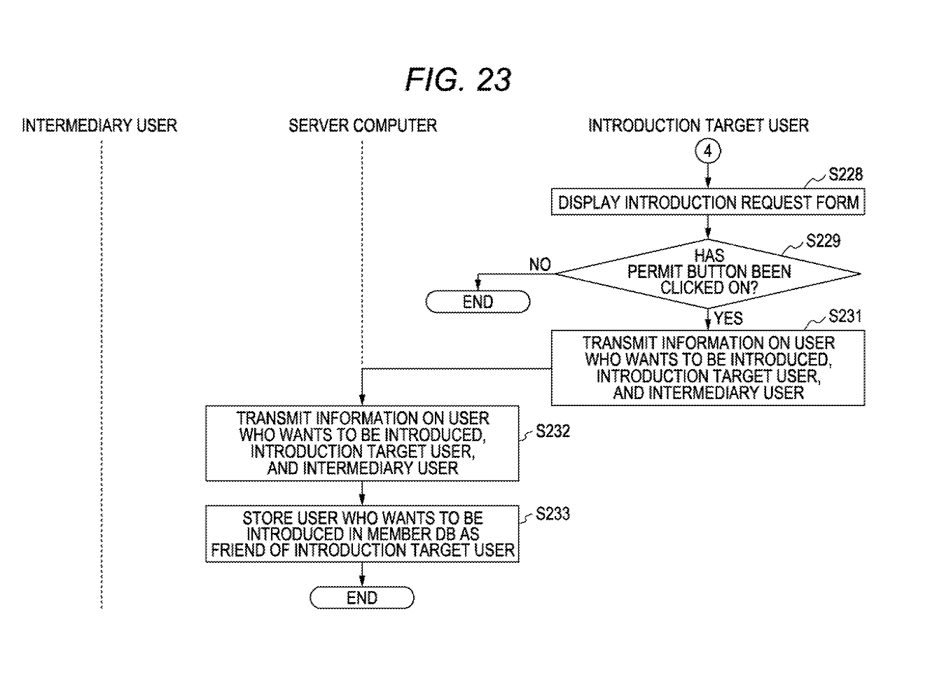

FIGS. 21 to 23 are operation flows showing procedures of the introduction request process. The CPU 21 of the personal computer 2 of the intermediary user causes the browser 251 to display the intermediacy request message as shown in FIG. 13 similarly to the operation S208 (operation S211). The CPU 21 determines whether the INTRODUCE button 131 serving as a trigger for proceeding with the following introduction request process has been clicked by the intermediary user on via the input unit 23 (operation S212). If the CPU 21 determines that the INTRODUCE button 131 has not been clicked on (i.e., the REPLY button has been clicked on) by the intermediary user (NO; operation S212), the CPU 21 determines that intermediacy is unnecessary and finishes a series of the process.

On the other hand, if the CPU 21 determines that the INTRODUCE button 131 has been clicked on by the intermediary user (YES; operation S212), the CPU 21 transmits the information on the user who wants to be introduced, the introduction target user, and the community to the server computer 1 (operation S213). In this example, the information on the user A, the user P, and the classic camera community is transmitted from the personal computer 2 of the user B to the server computer 1. The CPU 11 of the server computer 1 receives the information transmitted from the personal computer 2 of the intermediary user, and reads an introduction request form from the introduction request form file 157 (operation S214).

The CPU 11 sets the ID of the introduction target user as the destination and additionally writes the subject mentioning the name of the user who wants to be introduced in the subject box 141 on the introduction request form read in the operation S214 (operation S215), and transmits the introduction request form to the personal computer 2 of the intermediary user (operation S216). The CPU 21 of the personal computer 2 of the intermediary user receives the introduction request form (operation S217). The CPU 21 causes the browser 251 to display the introduction request form shown in FIG. 14 (operation S218). The intermediary user writes necessary information to the message box 142 via the input unit 23 (operation S219).

The CPU 21 accepts the information which is added to the introduction request form and inputted via the input unit 23. The CPU 21 transmits the introduction request form in which the introduction target user is set as the destination to the server computer 1 in response to click-on of the SEND button 143 by the intermediary user shown in FIG. 14 as a trigger (operation S220). The CPU 11 of the server computer 1 stores the introduction request form which the introduction target user (i.e., the user P in this example) is set as the destination in the introduction request form file 157 (operation S221). In this case, the CPU 11 also stores the information on the community and the user who wants to be introduced, the intermediary user, and the introduction target user in the introduction request form file 157 so as to correspond to one another. Thereafter, the intermediary user logs out (operation S222).

The CPU 11 of the server computer 1 determines whether or not the introduction target user (i.e., the user P in this example) has logged in (operation S223). If the CPU 11 determines that the introduction target user has not logged in (NO; operation S223), the CPU 11 repeats the same procedure until the introduction target user logs in. On the other hand, if the CPU 11 determines that the introduction target user has logged in (YES; operation S223), the CPU 11 reads the introduction request form in which the ID of the introduction target user is set as the destination from the introduction request form file 157 stored in the operation S221 (operation S224). The CPU 11 sets the ID of the intermediary user (i.e., the user B in this example) as a transmitter, reads the name and the photograph data of the user who wants to be introduced (i.e., the user A in this example) from the member DB 152. And the CPU 11 adds them to the introduction request form (operation S225). The CPU 11 transmits the introduction request form to the personal computer 2 of the introduction target user (i.e., the user P) (operation S226). The CPU 21 of the personal computer 2 of the introduction target user receives the introduction request form transmitted from the CPU 11 (operation S227), and causes the browser 251 to display the introduction request message as shown in FIG. 15 (operation S228).

The CPU 21 of the personal computer 2 of the introduction target user determines whether the PERMIT button 144 shown in FIG. 15 has been clicked on by the introduction target user via the input unit 23 (operation S229). If the CPU 21 determines that the PERMIT button 144 has not been clicked on (i.e., the STOP button 145 has been clicked on) (NO; operation S229), the CPU 21 determines that the introduction target user rejects to make a friendship with the user who wants to be introduced (i.e., the user A) to the introduction target user (i.e., the user P) despite the request from the intermediary user (i.e., the user B) who is the friend of the introduction target user. And the CPU 21 finishes a series of the process.

On the other hand, if determining that the PERMIT button 144 has been clicked on by the introduction target user (YES; operation S229), the CPU 21 transmits information on the user who wants to be introduced, the introduction target user, and the intermediary user to the server computer 1 (operation S231). The CPU 11 of the server computer 1 receives the information on the user who wants to be introduced, the introduction target user, and the intermediary user transmitted from the personal computer 2 of the introduction target user (operation S232). The CPU 11 stores the name, the ID, and the photograph data of the user who wants to be introduced in the storage region corresponding to the introduction target user in the member DB 152 as a friend of the introduction target user (operation S233). Likewise, the CPU 11 stores the name, the ID, and the photograph data of the introduction target user in the storage region corresponding to the user who wants to be introduced in the member DB 152 as a friend of the user who wants to be introduced.

### Second Embodiment

In the first embodiment, the example of monitoring whether the users E, F, and P who are friends of the user B who is included within the introduction range of the user A participate in the registered community has been described. Conversely, in the second embodiment, an example of monitoring whether a user (e.g., a user S whose ID is 10S) already participating in the community has become a friend of the user B who is included within the introduction range of the user A will be described.

In the second embodiment, similarly to the first embodiment, it is assumed that the friends of the user B who is the friend of the user A are included within the introduction range of the user A and that the classic camera community shown in FIG. 5 is the registered community. As shown in, for example, FIG. 5, members in the classic camera community are the user S (ID: 10S), a user T (ID: 10T), and a user U (ID: 10U). If one of the users S, T, and U becomes a friend of the user B who is included within the introduction range of user A, a notification process is performed.

The CPU 11 of the server computer 1 searches the community DB 151 for the classic camera community by referring to the communities stored in the registration file 154. And the CPU 11 extracts member IDs of users participating in the classic camera community. The CPU 11 determines whether one of the extracted member IDs is stored in the storage region for the user B who is included within the introduction range of the user A in the member DB 152 as a friend of the user B. Specifically, the introduction range up to the friends of the user B who is the friend of the user A is stored in the registration file 154 to correspond to the classic camera community (see FIG. 10). Therefore, the CPU 11 determines whether one of the extracted member IDs 10S, 10T, and 10U is stored in the storage region indicating a friendship with the user B in the member DB 152.

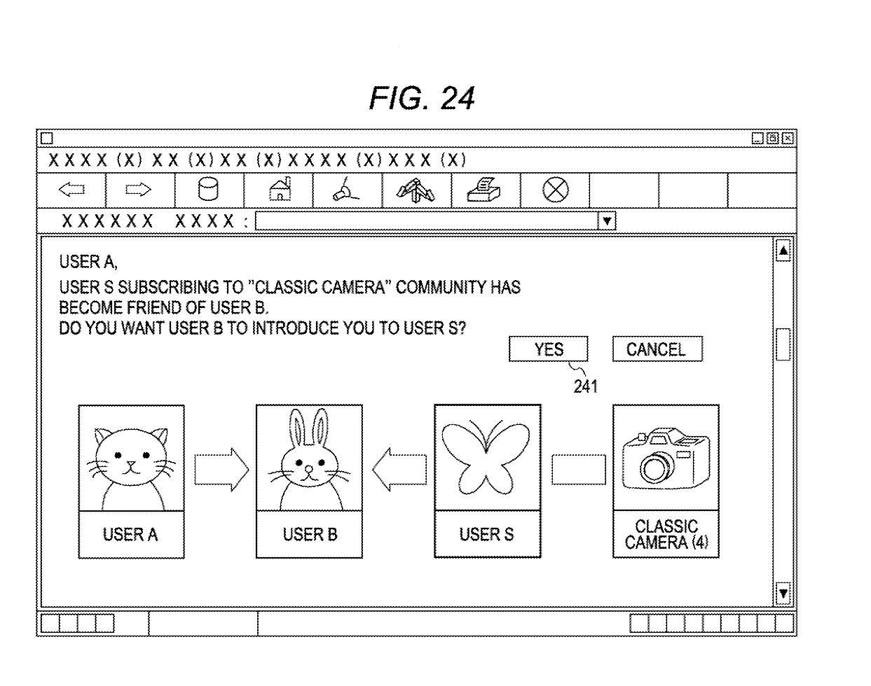

If the CPU 11 determines that one of the extracted member IDs 10S, 10T, and 10U is stored in the storage region indicating the friendship with the user B in the member DB 152, the CPU 11 performs a notification process on the personal computer 2 of the user A. FIG. 24 is an explanatory diagram showing an image of the notification form. In the notification form, information as to through which intermediary user the introduction target user participates in the registered community is visually recognizably described. In the example of FIG. 24, the name and the photograph of the user A who wants to be introduced are displayed on the left, and the name and the photograph of the intermediary user B who is the friend of the user A are displayed next to the user A across a right arrow indicating a request. Further, the name and the photograph of the user S are displayed next to the user B across a left arrow indicating that the user S has become a friend of the user B.

Moreover, the classic camera community that is the name and the photograph of the classic camera community in which the user A participates are displayed in the right of the user S across a thick line indicating that the user S already participates to the classic camera community. Further, a sentence of a request that the intermediary user B introduce the user A to the user S is written on an upper side of the notification form. The CPU 11 of the server computer 1 writes user names and the community on the notification form read from the notification form file 155 and then transmits the notification form to the personal computer 2 of the user A.

The YES button 111 is provided on the notification form. When the user A clicks on the YES button 111 via the input unit 23, the personal computer 2 of the user A who wants to be introduced to the user S transmits information on the introduction request to the server computer 1. A hyperlink is described in HTML on the YES button 111. When the user A clicks on the YES button 111, the CPU 21 of the personal computer 2 of the user A transmits the ID of the user A and the information on the introduction request to the server computer 1. Since the intermediacy process and the introduction request process after the YES button 241 is clicked on are similarly performed to those according to the first embodiment, their processes will not be described herein.

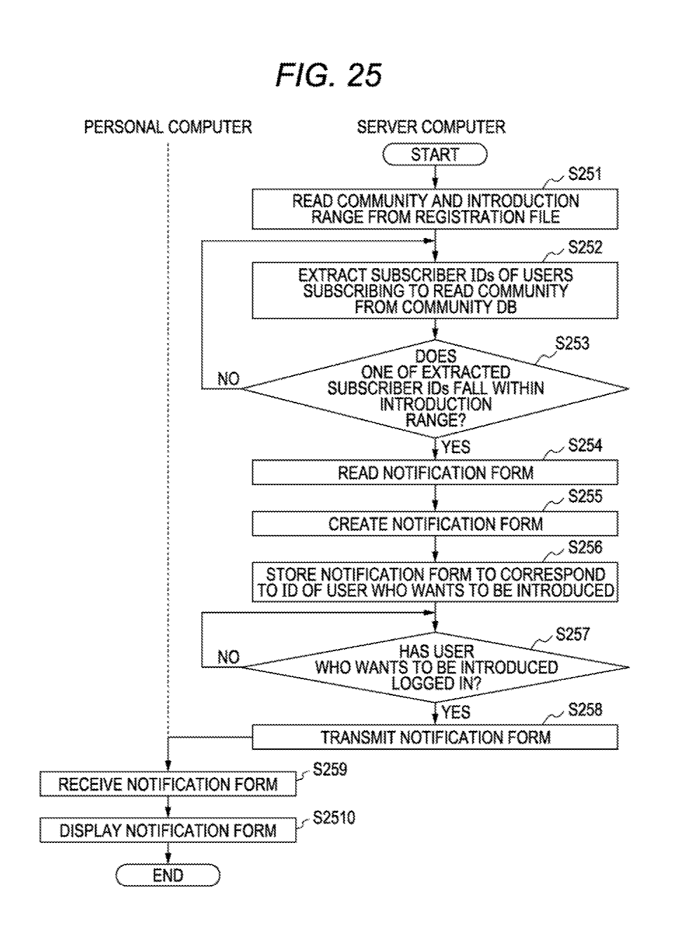

FIG. 25 is an operation flow showing procedures of the notification process according to the second embodiment. The CPU 11 of the server computer 1 reads information on the community and the introduction range of the community as monitoring targets from the registration file 154 (operation S251). In the second embodiment, the community is the classic camera community, and the introduction range of the classic camera community is “up to friends of the user B who is the friend of the user A”. The CPU 11 extracts member IDs of users participating in the read community from the community DB 151 (operation S252). In the second embodiment, the extracted member IDs are 10S, 10T, and 10U.

The CPU 11 determines whether one of the extracted member IDs is included within the introduction range (operation S253). Since the introduction range is “up to the friends of the user B who is the friend of the user A”, the CPU 11 monitors the storage region for the user B and determines whether one of the member IDs 10S, 10T, and 10U extracted as IDs of the friends of the user B is stored in the introduction range. If the CPU 11 determines that one of the extracted member IDs is not included within the introduction range (NO; operation S253), the process returns to the operation S252 and the procedures of the operations S252 and S253 are repeated. On the other hand, if the CPU 11 determines that one of the extracted members IDs is included within the introduction range (YES; operation S253), the CPU 11 reads a notification form from the notification form file 155 (operation S254). For example, the user S becomes the friend of the user B and is stored in the storage region for the user B in the member DB 152 as the friend of the user B.

The CPU 11 writes information on the user who wants to be introduced, the intermediary user, and the introduction target user with the photograph corresponding to each user in the notification form. The CPU 11 thereby creates the notification form shown in FIG. 24 (operation S255). The CPU 11 stores the created notification form in the notification form file 155 to correspond to the ID of the user who wants to be introduced (operation S256). In the second embodiment, the CPU 11 stores the notification form created to correspond to the ID of the user A in the notification form file 155.

The CPU 11 determines whether the user who wants to be introduced has logged in (operation S257). If the CPU 11 determines that the user who wants to be introduced has not logged in (NO; operation S257), the same procedures are repeated. If the CPU 11 determines that the user who wants to be introduced has logged in (YES; operation S257), the CPU 11 reads the created notification form corresponding to the login user from the notification form file 155. And the CPU 11 transmits the notification form to the personal computer 2 of the login user (operation S258). When the CPU 21 of the personal computer 2 receives the notification form transmitted from the server computer 1 (operation S259), the CPU 21 causes the browser 251 to display the notification form as shown in FIG. 24 (operation S2510).

The notification process performed by the introduction supporting system according to the second embodiment includes the configuration as stated above. The other configurations and processes are similar to those according to the first embodiment. Therefore, corresponding constituent elements are denoted by the same reference symbols and will not be described in detail herein.

### Third Embodiment

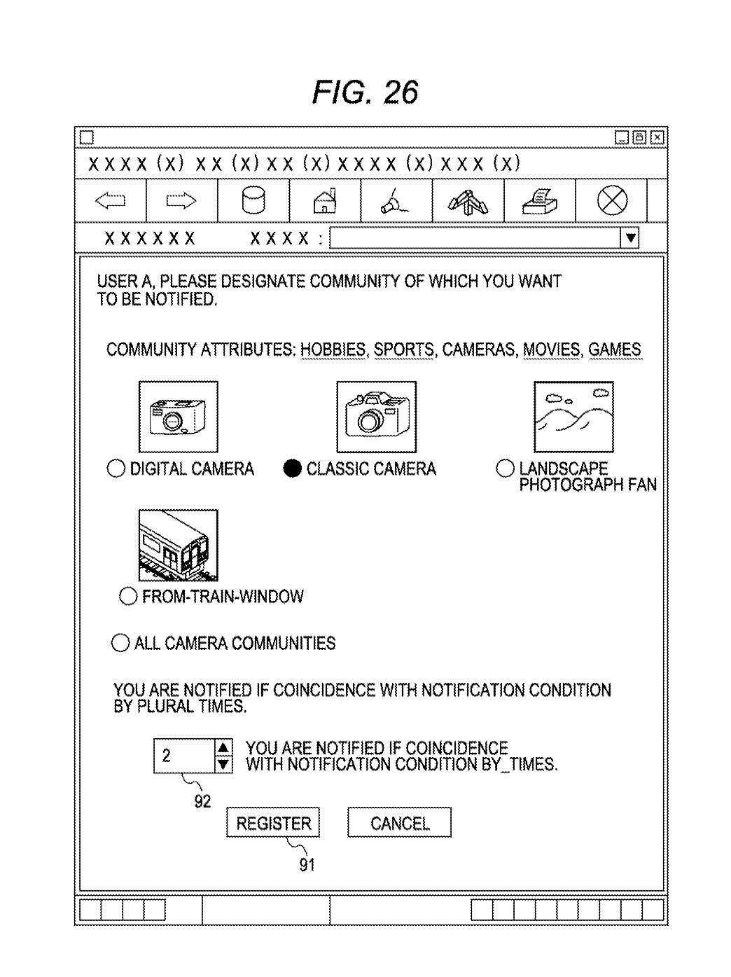

An introduction supporting system according to a third embodiment of the present invention performs a notification process if the number of times of coincidence with a registered notification condition is equal to or greater than a predetermined number of times registered in advance. FIG. 26 is an explanatory diagram showing an image of a community registration screen according to the third embodiment. The user A designates a community of which the user A wants to be notified via the input unit 23. A numeric value input box 92 is provided on the community registration screen. The user A inputs a desired numeric value via the input unit 23. If the number of times of coincidence with the notification condition is equal to or greater than the input numeric value, the notification process shown in FIG. 11 is performed.

For example, 2 as the numeric value is set to a predetermined number of times. In the first embodiment, if two out of the users E, F, and P who are the friends of the user B participate in the classic camera community, the notification process shown in FIG. 11 is performed. In the second embodiment, if two out of the users S, T, and U who are members of the classic camera community become friends of the user B, the notification process shown in FIG. 24 is performed. In the example of FIG. 26, the user A designates the community or the attribute of the community and further inputs a numeric value to the numeric value input box 92. Thereafter, the CPU 21 of the personal computer 2 of the user A transmits the input information and numeric value about the community to the server computer 1 in response to detection of click-on of the REGISTER button 91 of the user A as a trigger.

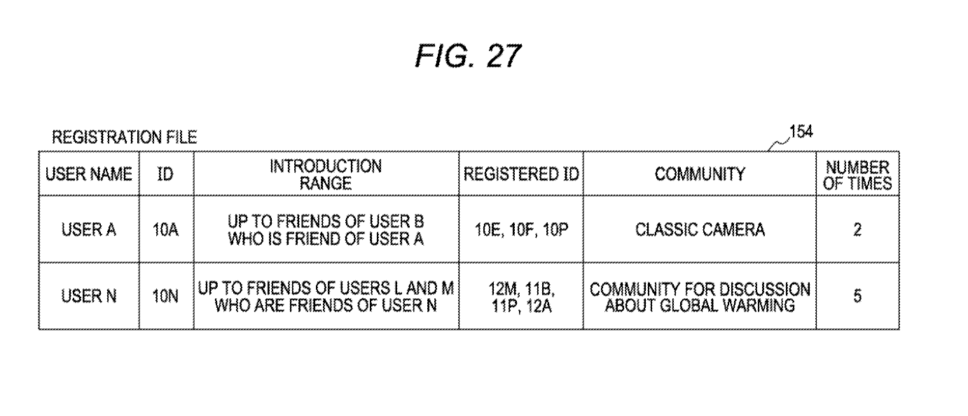

FIG. 27 is an explanatory diagram showing a record layout of the registration file 154 according to the third embodiment. An ID, an introduction range, registered IDs indicating IDs of users that are included within the introduction range, a community, and the number of times are stored in the registration file 154 to correspond to each user. In the example of FIG. 26, the user A sets 2 as the numeric value, so that 2 is stored in the number of times field corresponding to the user A.

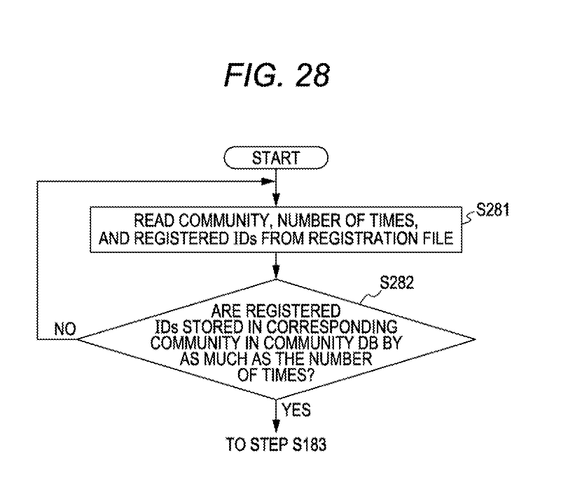

FIG. 28 is an operation flow showing procedures of the notification process according to the third embodiment. The CPU 11 of the server computer 1 reads the community, the number of times, and the registered IDs from the registration file 154 shown in FIG. 27 as monitoring targets (operation S281). In the example of FIG. 27, the community in which the user A participates is the classic camera community, the number of times is 2, and the registered IDs are 10E, 10F, and 10P. The CPU 11 determines whether the monitoring target registered IDs are stored by as many as the read number of times while referring to the member ID field corresponding to the monitoring target community in the community DB 151 (operation S282). If the CPU 11 determines that the registered IDs are not stored by as many as the read number of times (NO; operation S282), the process returns to the operation S281 and the procedures of the operations S281 and S282 are repeated.

On the other hand, if the CPU 11 determines that the registered IDs are stored by as many as the read number of times (YES; operation S282), the procedures in the operations S183 and the subsequent operations described in the first embodiment are executed. It is assumed, for example, that the users P and F participate in the classic camera community. In this case, the CPU 11 performs a process for creating two notification forms in which the intermediary user is the user B and in which introduction target users are the users P and F, respectively.

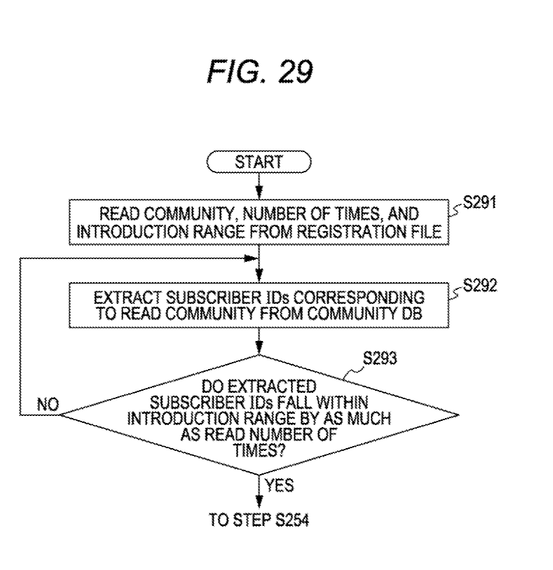

FIG. 29 is an operation flow showing procedures of another notification process according to the third embodiment. The notification process shown in FIG. 29 is performed if the third embodiment is applied to the second embodiment. The CPU 11 of the server computer 1 reads a record including data items which are the community, the number of times, and the introduction range from the registration file 154 shown in FIG. 27 as monitoring targets (operation S291). For example, the CPU 11 reads a record including data which is “the classic camera community”, “2”, and “up to friends of the user B who is the friend of the user A” from the registration file 154. The CPU 11 extracts member IDs of users participating in the read community from the community DB 151 (operation S292). For example, the CPU 11 extracts the member IDs 10S, 10T, and 10U.

The CPU 11 determines whether the extracted member IDs are including within the introduction range by as many as the read number of times while referring to the member DB 152 shown in FIG. 4 (operation S293). Since the introduction range is “up to friends of the user B who is the friend of the user A”, the CPU 11 monitors the storage region for the user B and determines whether two out of the users having the extracted IDs 10S, 10T, and 10U are stored in the introduction range. If the CPU 11 determines that the member IDs extracted by as many as the read number of times is not included within the introduction range (NO; operation S293), the process returns to the operation S292 and the procedures of the operations S292 and S293 are repeated.

On the other hand, if the CPU 11 determines that the member IDs extracted by as many as the read number of times is included within the introduction range (YES; operation S293), the process goes to the operation S254 described in the second embodiment. For example, if the users S and T become friends of the user B, the information on the users S and T are stored in the storage region for the user B in the member DB 152 as the friends of the user B. In this case, the CPU 11 performs a process for creating two notification forms in which the intermediary user is the user B and in which the introduction target users are users S and T, respectively. When each user sets the number of max times which indicates the introduction range as stated above, it is possible to select favorite users as friends of each user after information is collected to some extent.

The introduction supporting system according to the third embodiment is similar in configuration and function to the first and second embodiments except for the notification process. Therefore, such constituent elements and functions are denoted by the same reference symbols as both the constituent elements and the functions according to the first and second embodiments and will not be described herein in detail.

### Fourth Embodiment

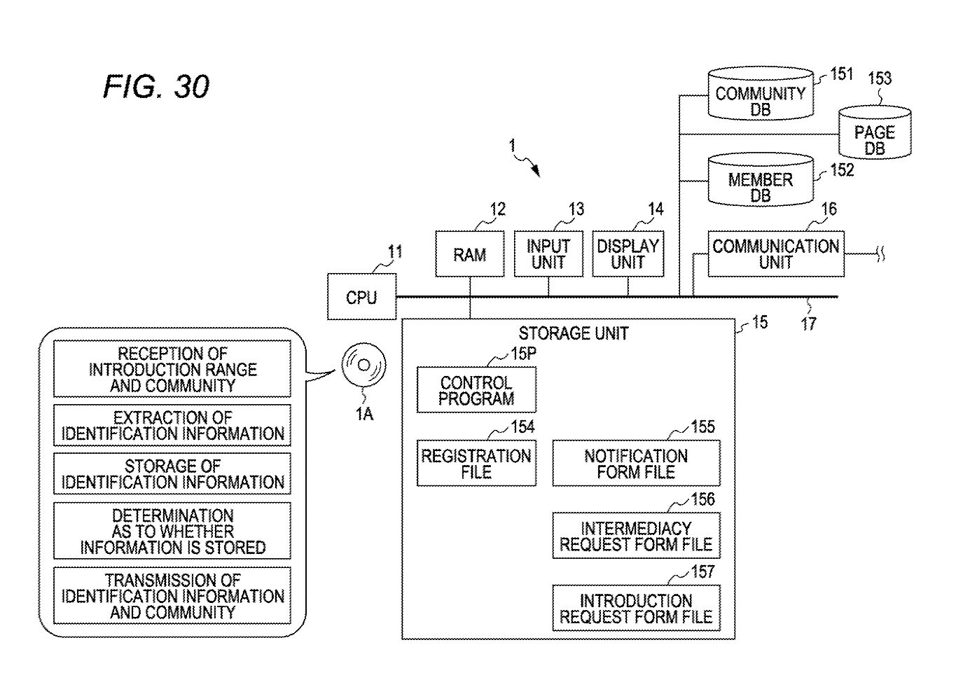

FIG. 30 is a block diagram showing a configuration of a server computer 1 included in an introduction supporting system according to a fourth embodiment of the present invention. A computer program for causing the server computer 1 according to each of the first to third embodiments to operate can be stored in the storage unit 15 by causing a recording medium reader (not shown) to read the computer program from a recording medium 1A such as a CD-ROM, or can be downloaded from the other computer (not shown) connected to the server computer 1 via the communication network N as shown in FIG. 30 according to the fourth embodiment. The manner of downloading the computer program will be described more specifically below.

The server computer 1 shown in FIG. 30 downloads the program for the reception of information on the introduction ranges and the communities and the other processes or functions from the other computer (not shown) via either the recording medium 1A or the communication unit 16. The program is installed as the control program 15P included in the storage unit 15 of the server computer 1. The program is loaded to and executed by the RAM 12. As a result, the server computer 1 according to each of the first to third embodiments is caused to operate as such.

The server computer 1 according to the fourth embodiment is similar in configuration to those according to the first to third embodiments. Therefore, such constituent elements and functions are denoted by the same reference symbols as both the constituent elements and the functions according to the first to third embodiments and will not be described herein in detail.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An introduction supporting apparatus for supporting an introduction among a plurality of users, said apparatus comprising:
a receiving unit receiving both information on a community and an introduction range corresponding to first identification information on a first user from an information processing apparatus of the first user, the first user seeks introduction, the community is one in which the first user is interested in joining, the introduction range is a number of max times intermediating between the first user and a target user to whom the first user seeks introduction;
a member database storing identification information on the plurality of users including both the first user and a second user who has an established relationship with the first user;
a community database storing identification information on users belonging to the community;
an extracting unit extracting target identification information on the target user from the member database using both the first identification information and the introduction range;
a determining unit determining whether the extracted target identification information has been stored in the community database related to the community corresponding to the received information on the community; and
a transmitting unit transmitting the extracted target identification information and the received information on the community to the information processing apparatus when the determining unit determines that the extracted target identification information has been stored in the community database.

2. The introduction supporting apparatus according to claim 1,
wherein the extracting unit extracts the target identification information from the community database using the received information on the community,
the determining unit determines whether the target user is registered within the transmitted introduction range while referring to the member database, and
the transmitting unit transmits the target identification information and the received information on the community to the information processing apparatus when the determining unit determines that the target identification information is included within the transmitted introduction range.

3. The introduction supporting apparatus according to claim 1,
wherein, when the determining unit determines that the extracted target identification information has been stored in the community database or that the extracted target identification information is included within the transmitted introduction range, the transmitting unit transmits the extracted target identification information and the information on the community to the information processing apparatus.

4. The introduction supporting apparatus according to claim 2,
wherein, when the determining unit determines that the extracted target identification information has been stored in the community database or that the introduction target user is included within the transmitted introduction range, the transmitting unit transmits the extracted target identification information and the information on the community to the information processing apparatus.

5. The introduction supporting apparatus according to claim 1, further comprising:
a reading unit reading third identification information on an intermediary user who is included within the introduction range from the member database when the determining unit determines that the extracted target identification information has been stored in the community database or that the target user is included within the transmitted introduction range,
wherein the transmitting unit transmits the read third identification information on the intermediary user, the identification information on the target user, and the information on the community to the information processing apparatus corresponding to the target identification information.

6. The introduction supporting apparatus according to claim 2, further comprising:
a reading unit reading third identification information on an intermediary user who is included within the introduction range from the member database when the determining unit determines that the extracted target identification information has been stored in the community database or that the target user is included within the transmitted introduction range,
wherein the transmitting unit transmits the read third identification information, the target identification information, and the information on the community to the information processing apparatus.

7. The introduction supporting apparatus according to claim 3, further comprising:
a reading unit reading third identification information on an intermediary user who is included within the introduction range from the member database when the determining unit determines that the extracted target identification information has been stored in the community database or that the target user is included within the transmitted introduction range,
wherein the transmitting unit transmits the read third identification information, the target identification information, and the information on the community to the information processing apparatus corresponding to the first identification information.

8. The introduction supporting apparatus according to claim 4, further comprising:
a reading unit reading third identification information on an intermediary user who is included within the introduction range from the member database if the determining unit determines that the extracted target identification has been stored in the community database or that the target user is included within the transmitted introduction range,
wherein the transmitting unit transmits the read third identification information, the target identification information, and the information on the community to the information processing apparatus.

9. The introduction supporting apparatus according to claim 5, further comprising:
an intermediacy transmitting unit transmitting an intermediacy request form to the information processing apparatus, the third identification information described in a destination of the intermediacy request form; and
an introduction transmitting unit transmitting an introduction request form to the information processing apparatus, the second identification information described as a destination of the introduction request form.

10. The introduction supporting apparatus according to claim 6, further comprising:
an intermediacy transmitting unit transmitting an intermediacy request form to the information processing apparatus, the third identification information described in a destination of the intermediacy request form; and
an introduction transmitting unit transmitting an introduction request form to the information processing apparatus, the target identification information described as a destination of the introduction request form.

11. The introduction supporting apparatus according to claim 7, further comprising:
an intermediacy transmitting unit transmitting an intermediacy request form to the information processing apparatus, the third identification information described as a destination of the intermediacy request form; and
an introduction transmitting unit transmitting an introduction request form to the information processing apparatus, the target identification information described in a destination of the introduction request form.

12. The introduction supporting apparatus according to claim 8, further comprising:
an intermediacy transmitting unit transmitting an intermediacy request form to the information processing apparatus, the third identification information described in a destination of the intermediacy request form; and
an introduction transmitting unit transmitting an introduction request form to the information processing apparatus, the target identification information described in a destination of the introduction request form.

13. The introduction supporting apparatus according to claim 5,
wherein the introduction range is the number of max times of users intermediating between the first user and the target user.

14. The introduction supporting apparatus according to claim 6,
wherein the introduction range is the number of max times of users intermediating between the first user and the target user.

15. The introduction supporting apparatus according to claim 7,
wherein the introduction range is the number of max times of users intermediating between the first user and the target user.

16. The introduction supporting apparatus according to claim 8,
wherein the introduction range is the number of max times of users intermediating between the first user and the target user.

17. A computer readable recording medium storing a program for causing a computer to support an introduction among a plurality of users, the program comprising operations of:
receiving both information on a community and an introduction range corresponding to first identification information on a first user who seeks introduction, from a information processing apparatus of the first user, the community is one in which the first user is interested in joining, the introduction range is a number of max times intermediating between the first user and a target user to whom the first user seeks introduction;
storing identification information on users belonging to the community in a community database;
extracting target identification information on the target user from a member database storing identification information on the plurality of users including the first identification information and second identification information on a second user who has an established relationship with the first user using both the first identification information and the received introduction range;
determining whether the extracted target identification information has been stored in the community database related to the community corresponding to the received information on the community; and
transmitting the extracted target identification information and the received information on the community to the information processing apparatus when the operation of determining determines that the extracted target identification information has been stored in the community database.

18. The computer readable recording medium according to claim 17,
wherein the operation of extracting extracts the target identification information from the community database stored the identification information on the community using the received information on the community,
the operation of determining determines whether the target user is included within the transmitted introduction range while referring to the member database storing the identification information on the plurality of users including the first user and the second user, and
the operation of transmitting transmits both the target identification and the received information on the community to the information processing apparatus when the operation of determining determines that the target user is included within the transmitted introduction range.

19. An introduction supporting method for supporting an introduction among a plurality of users, said introduction supporting method comprising steps of:
receiving both information on a community in which a first user who seeks introduction is interested in joining, and an introduction range from the first user to an target user to whom the first user seeks introduction;
storing identification information on users belonging to the community in a community database in advance;
extracting target identification information on the target user from a member database stored identification information on the plurality of users including both the first identification information and second identification information on a second user having an established relationship with the first user using the first identification information and the introduction range;
determining whether the extracted target identification information has been stored in the community database related to the community corresponding to the received information on the community; and
transmitting both the extracted target identification information and the information on the community to the information processing apparatuses when the step of determining determines that the extracted target identification information has been stored in the community database.

20. The introduction supporting method according to claim 19,
wherein the step of extracting extracts the target identification information from the community database stored the identification information on the community using the received information on the community,
the step of determining determines whether the target user corresponding to the extracted target identification information is included within the received introduction range while referring to the member database storing the identification information on the plurality of users including both the first identification information and the second identification information, and
the step of transmitting transmits the target identification information and the information on the community to the information processing apparatuses when the step of determining determines that the target identification information is added within the transmitted introduction range.
